(19) United States
(12) Patent Application Publication
(10) Pub. No.: US 2007/0294155 A1
(43) Pub. Date: Dec. 20, 2007

(54) Apparatus, system, method, and computer program for managing transactions involving aviation assets

(75) Inventor: Geoffrey Paul Raynor, Fort Worth, TX (US)

Correspondence Address: DOCKET CLERK, P.O. DRAWER 800889, DALLAS, TX, 75380, US

(73) Assignee: Renegade Swish, LLC, Fort Worth, TX (US)

(21) Appl. No.: 11/524,706

(22) Filed: Sep. 21, 2006

Related U.S. Application Data
(60) Provisional application No. 60/809,644, filed on May 31, 2006.

(51) Int. Cl. G06Q 40/00

(52) U.S. Cl. 705/35

(57) ABSTRACT

An apparatus, system, method, and computer program for managing transactions involving aviation assets are provided. A graphical display is generated for presentation to one or more users. The graphical display contains information associated with an aviation asset and a list of steps associated with a transaction involving the aviation asset. Input from the one or more users is received indicating completion of each step associated with the transaction. The steps to be completed vary based on a transaction type associated with the transaction.

### CROSS-REFERENCE TO RELATED APPLICATIONS

This application claims priority under 35 U.S.C. § 119(e) to U.S. Provisional Patent Application No. 60/809,644 filed on May 31, 2006, which is hereby incorporated by reference.

### TECHNICAL FIELD

This disclosure is generally directed to management systems. More specifically, this disclosure is directed to an apparatus, system, method, and computer program for managing transactions involving aviation assets.

### BACKGROUND

The management of aviation assets, from small personal aircraft up to larger aircraft such as 767s and A330s, is typically a difficult and time-consuming process. For example, a lengthy and complex procedure usually must occur in order to lease or sell an aircraft to an air carrier. Among other reasons, the procedure is typically lengthy and complex because a transaction involving aircraft can often involve tens or hundreds of millions of dollars. Any mistakes or oversights in the transaction could result in huge financial losses or other liabilities for one or more parties to the transaction.

### SUMMARY

This disclosure provides an apparatus, system, method, and computer program for managing transactions involving aviation assets.

In a first embodiment, an apparatus includes at least one memory operable to store information associated with an aviation asset. The apparatus also includes at least one processor operable to generate a graphical display for presentation to one or more users.

The graphical display contains at least a portion of the information associated with the aviation asset and a list of steps associated with a transaction involving the aviation asset. The at least one processor is also operable to receive input from the one or more users indicating completion of each step associated with the transaction. The steps to be completed vary based on a transaction type associated with the transaction.

In particular embodiments, multiple users are required to indicate completion of at least one of the steps, and the multiple users are associated with different roles in the transaction. The different roles could represent different responsibilities or areas of expertise.

In other particular embodiments, the aviation asset includes a sub-asset, and the transaction represents a transaction associated with only the sub-asset and not the entire aviation asset. For example, the transaction could involve an exchange of an engine between two different aircraft.

In yet other particular embodiments, the list of steps includes a list of analyses associated with the transaction and a score associated with each analysis. Also, the at least one processor is further operable to determine an overall score associated with the transaction based on the scores associated with the analyses.

In still other particular embodiments, the transaction represents a current transaction, and the aviation asset is associated with a prior transaction. Also, at least some of the steps associated with the current transaction are completed based on the prior transaction.

In a second embodiment, a method includes receiving information associated with an aviation asset. The method also includes generating a graphical display for presentation to one or more users. The graphical display contains at least a portion of the information associated with the aviation asset and a list of steps associated with a transaction involving the aviation asset. In addition, the method includes receiving input from the one or more users indicating completion of each step associated with the transaction. The steps to be completed vary based on a transaction type associated with the transaction.

In a third embodiment, a computer program is embodied on a computer readable medium and is operable to be executed by a processor. The computer program includes computer readable program code for receiving information associated with an aviation asset. The computer program also includes computer readable program code for generating a graphical display for presentation to one or more users. The graphical display contains at least a portion of the information associated with the aviation asset and a list of steps associated with a transaction involving the aviation asset. In addition, the computer program includes computer readable program code for receiving input from the one or more users indicating completion of each step associated with the transaction. The steps to be completed vary based on a transaction type associated with the transaction.

In a fourth embodiment, a system includes a database operable to store information associated with an aviation asset. The system also includes a server operable to generate a graphical display for presentation to one or more users. The graphical display contains at least a portion of the information associated with the aviation asset and a list of steps associated with a transaction involving the aviation asset. The server is also operable to receive input from the one or more users indicating completion of each step associated with the transaction. The steps to be completed vary based on a transaction type associated with the transaction. In addition, the system includes at least one user device operable to display the graphical display and provide the input from the one or more users to the server.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawing, in which:

FIG. 1 illustrates an example system for managing transactions involving aviation assets in accordance with this disclosure;

FIGS. 2 through 42 illustrate an example graphical user interface for managing transactions involving aviation assets in accordance with this disclosure; and

FIGS. 43 through 51 illustrate example methods for managing transactions involving aviation assets in accordance with this disclosure.

### DETAILED DESCRIPTION

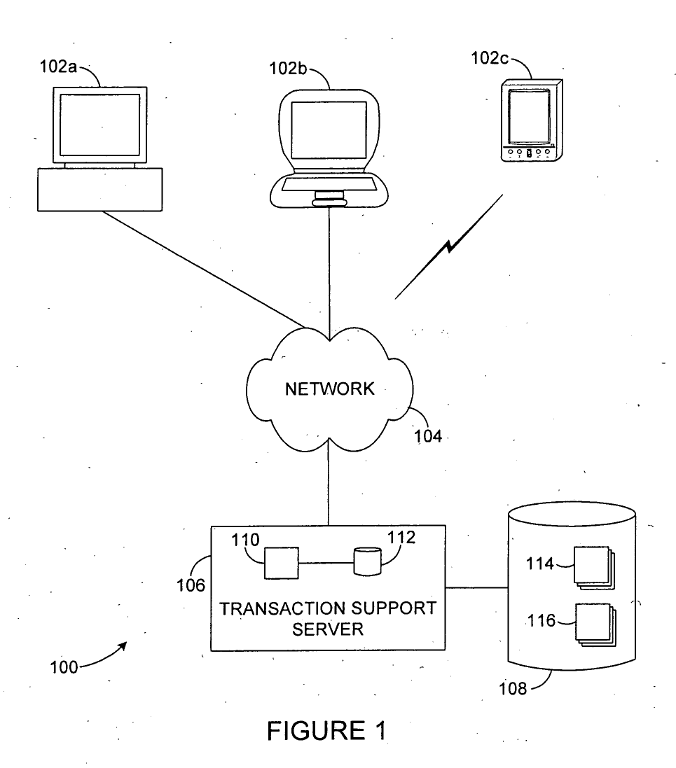

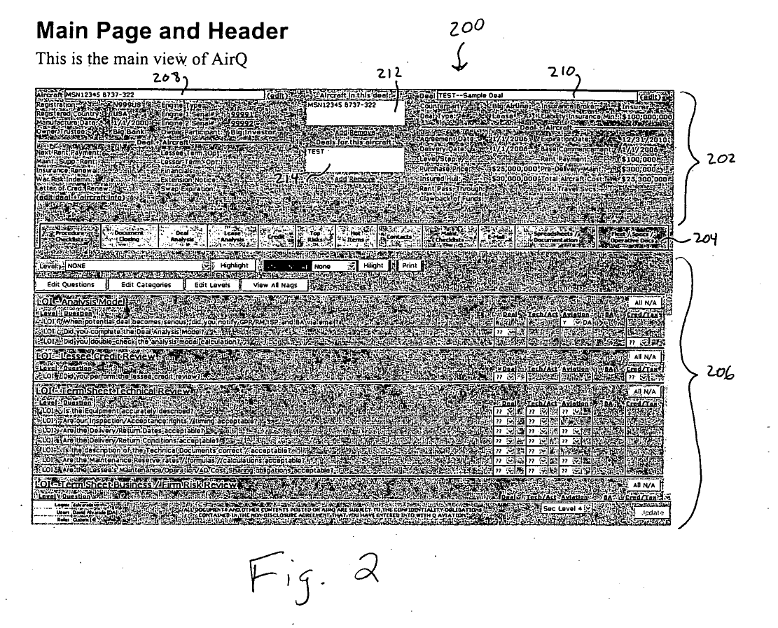

FIG. 1 illustrates an example system 100 for managing transactions involving aviation assets in accordance with this disclosure. In the illustrated example, the system 100 includes multiple user devices 102a-102c, a network 104, a transaction support server 106, and a database 108. This embodiment of the system 100 is for illustration only. Other embodiments of the system 100 may be used without departing from the scope of this disclosure.

In one aspect of operation, a user uses one of the user devices 102a-102c (referred to as “user devices 102”) to access the transaction support server 106. Among other things, the transaction support server 106 presents a graphical user interface to the user that identifies the procedures and requirements for a transaction involving aviation assets. The user may indicate that certain steps of the procedures have been completed, and the transaction support server 106 may verify that particular requirements have been met. The transaction support server 106 may also store information about various aspects of transactions and aviation assets in the database 108. In this way, the transaction support server 106 may facilitate completion of the various procedures associated with transactions involving aviation assets. In this document, the phrase “aviation assets” generally includes aircraft and their associated parts, where an aircraft could represent an aircraft of any size, function, and purpose.

In the illustrated embodiment, each user device 102 is capable of communicating with the network 104. Each user device 102 represents any suitable device, system, or portion thereof that allows a user to communicate and interact with the transaction support server 106. For example, a user device 102 may allow a user to access the transaction support server 106 and identify an aircraft or a transaction. The user device 102 may also allow the user to receive or provide various information about an aircraft or a transaction and to verify that particular steps of a procedure have been completed. In this example, the user devices 102 include a desktop computer, a laptop computer, and a personal digital assistant, each of which communicates over a wireline or wireless connection. These user devices 102 and their associated connections are for illustration only. Any other or additional computing or communication devices may be used in the system 100. Each user device 102 includes any hardware, software, firmware, or combination thereof for accessing the transaction support server 106.

The network 104 is capable of communicating with the user devices 102 and the transaction support server 106. The network 104 facilitates communication between components of the system 100. For example, the network 104 may communicate Internet Protocol (IP) packets, frame relay frames, Asynchronous Transfer Mode (ATM) cells, or other suitable information. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The transaction support server 106 is coupled to the network 104 and the database 108. The transaction support server 106 supports transactions involving aviation assets. For example, the transaction support server 106 may receive an identification of an aircraft or a transaction from a user. The transaction support server 106 allows the user to indicate that various steps in a procedure have been completed and verifies whether particular requirements have been met. The transaction support server 106 also allows the user to provide various information about different aspects of an aircraft or a transaction, and the transaction support server 106 accumulates and stores a wide variety of information in the database 108.

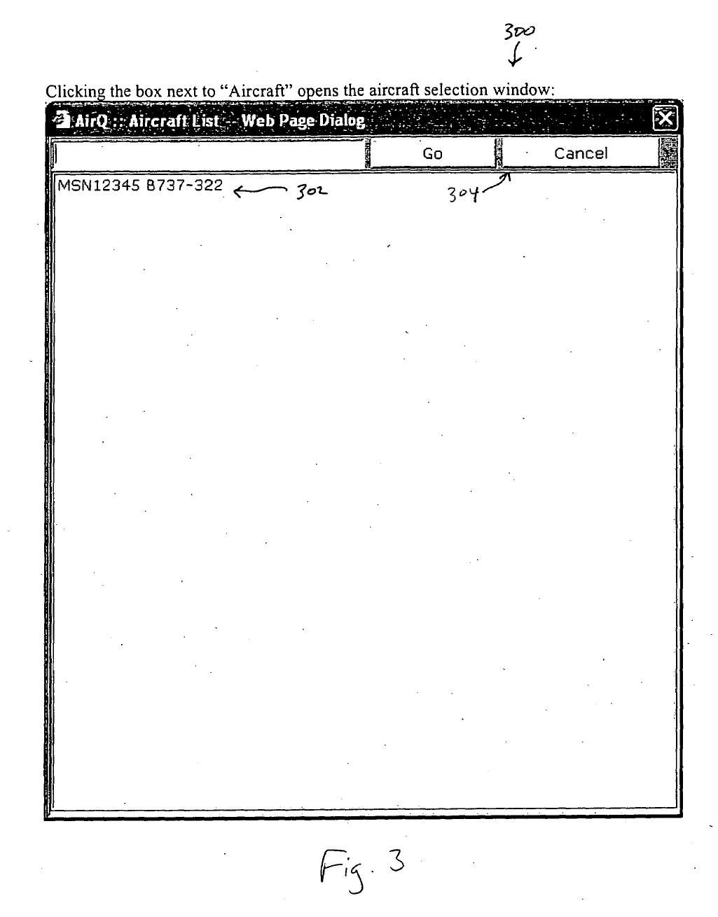

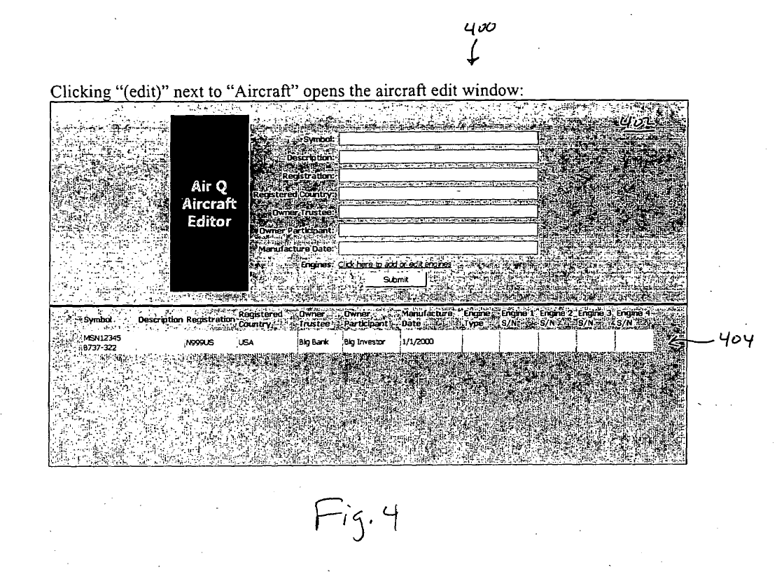

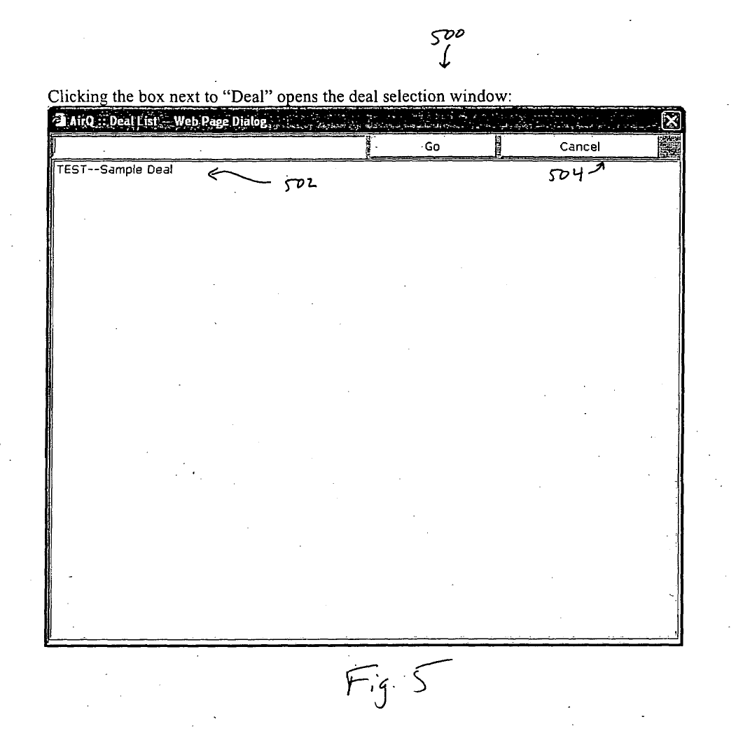

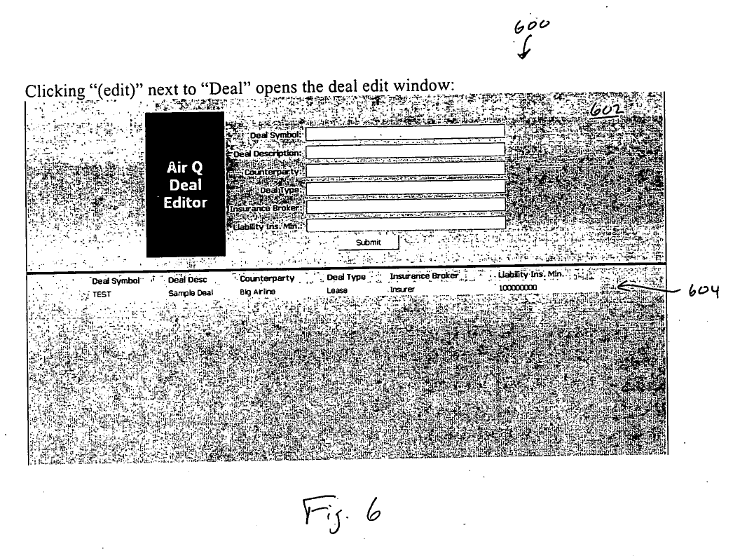

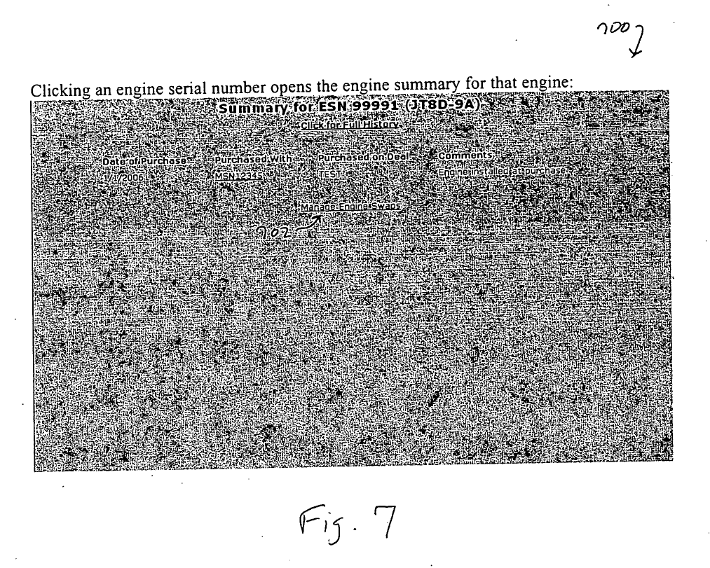

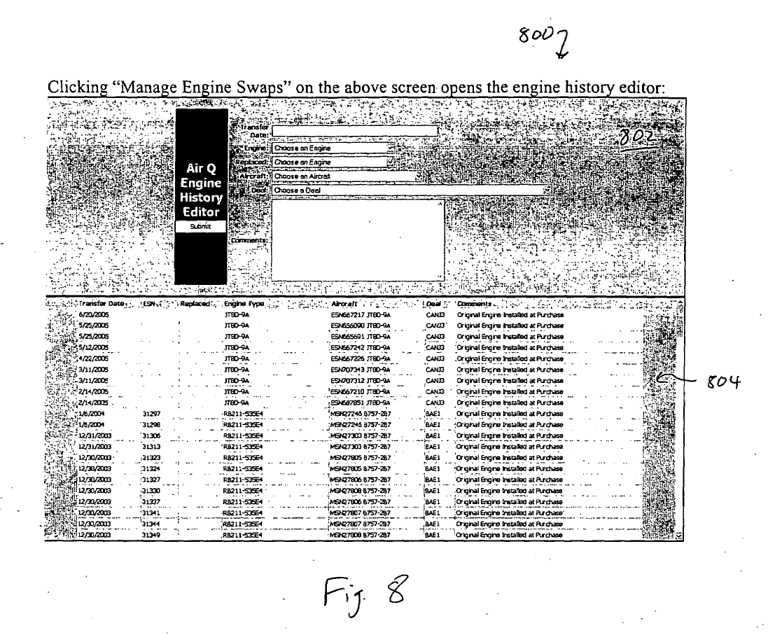

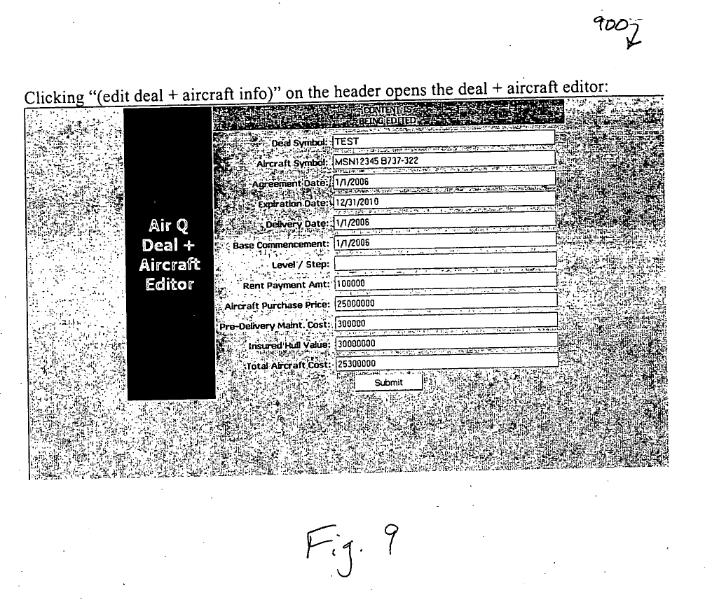

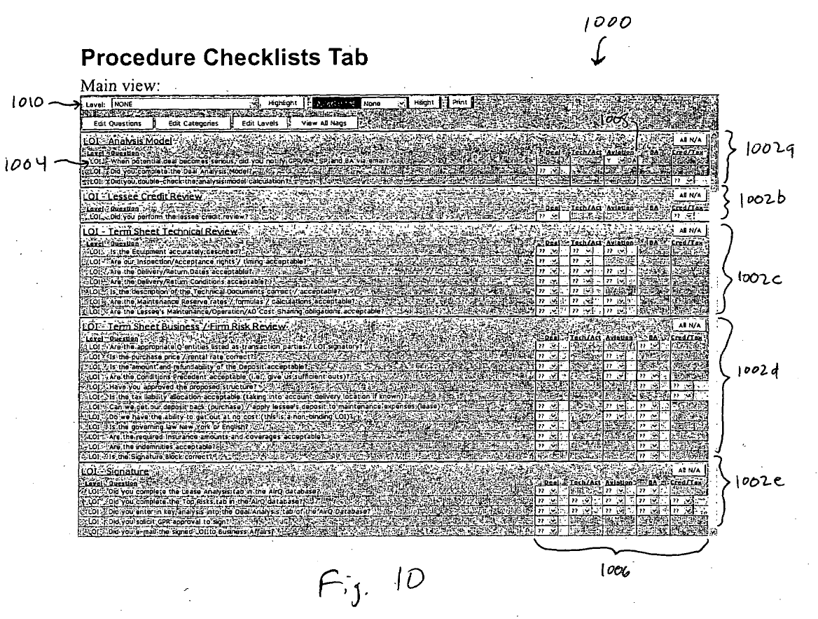

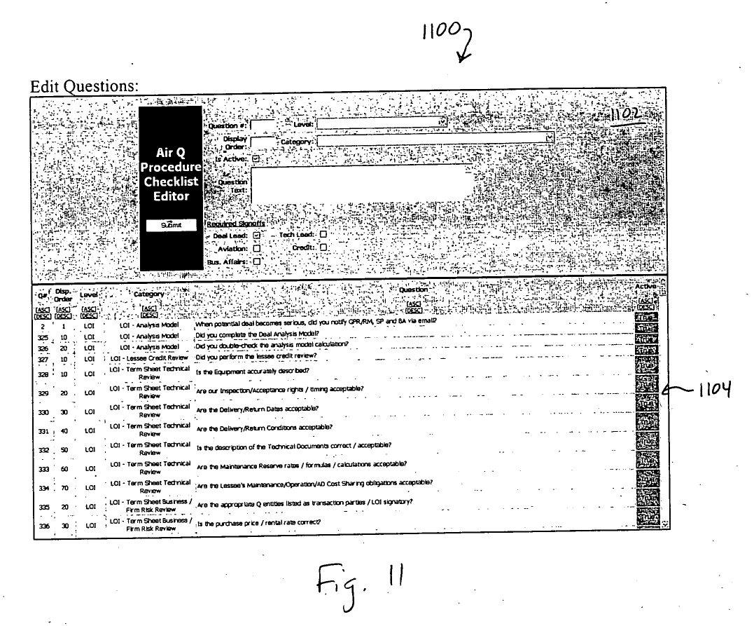

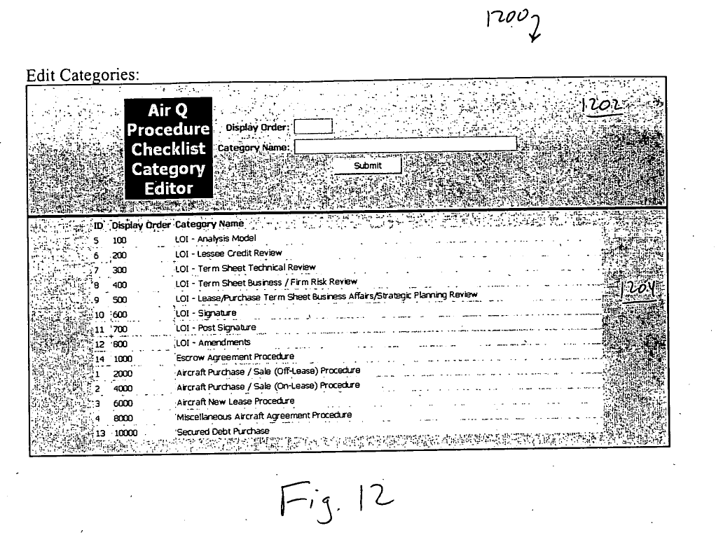

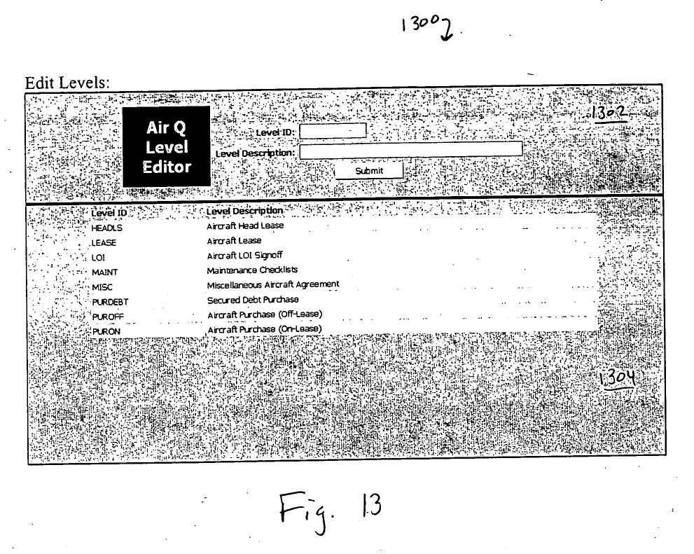

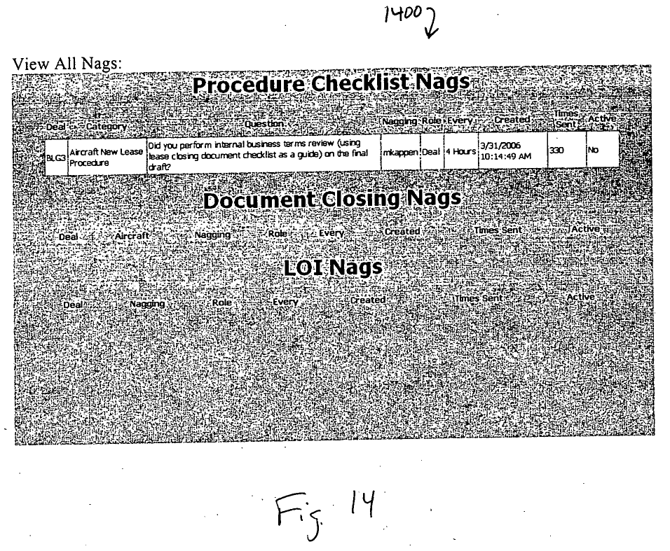

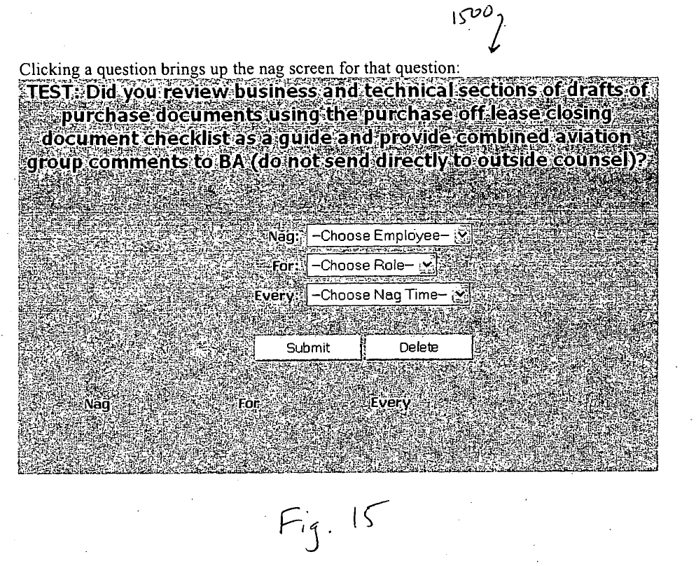

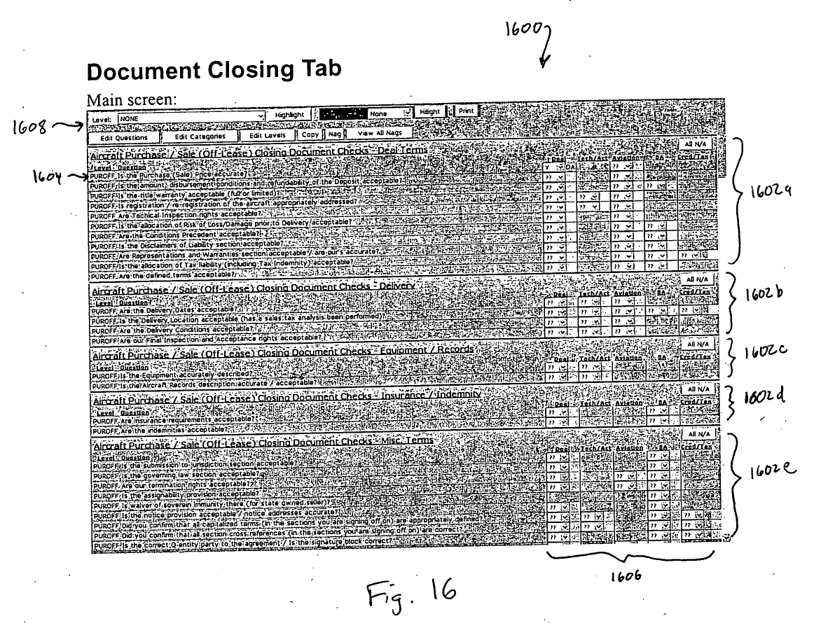

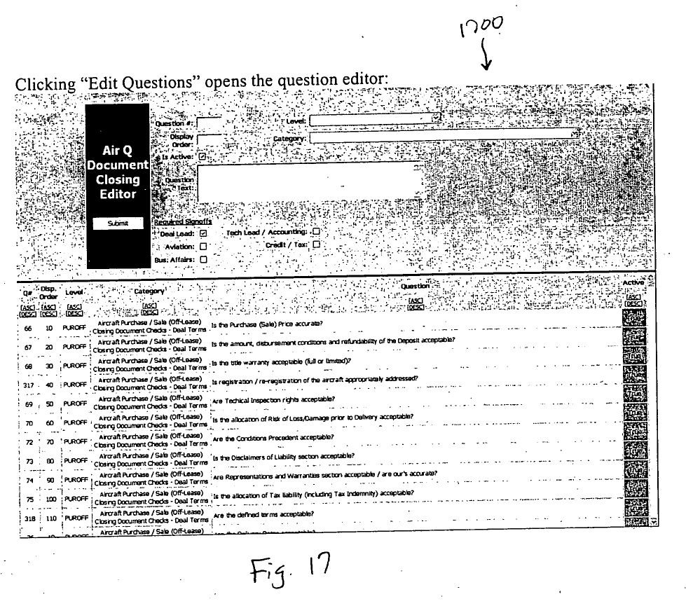

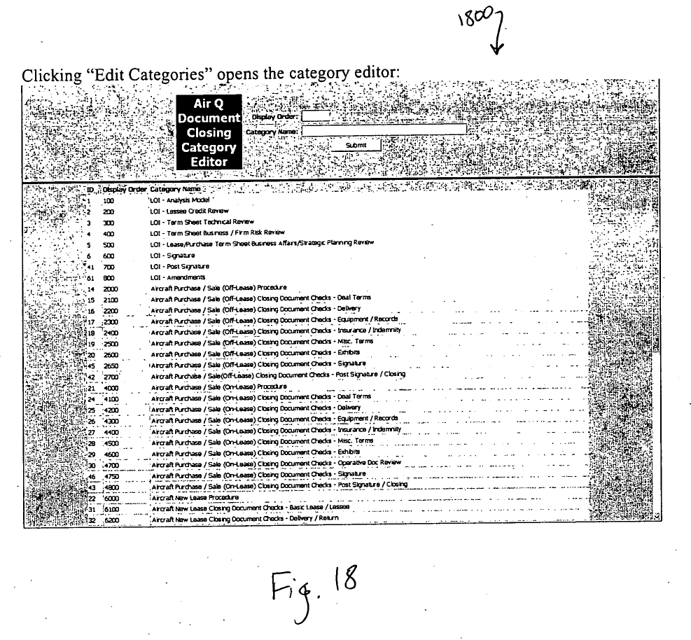

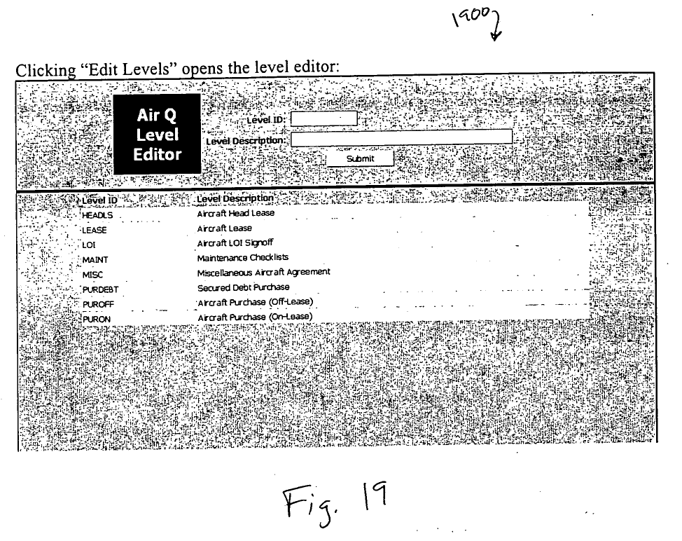

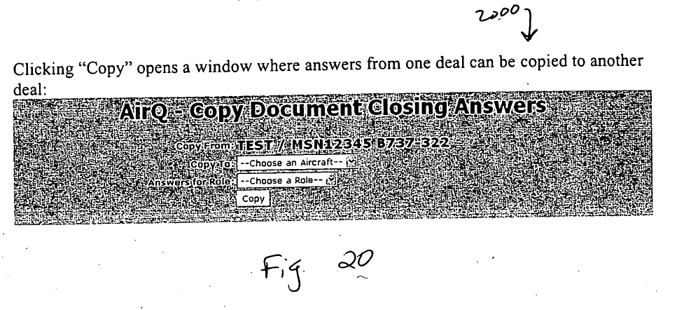

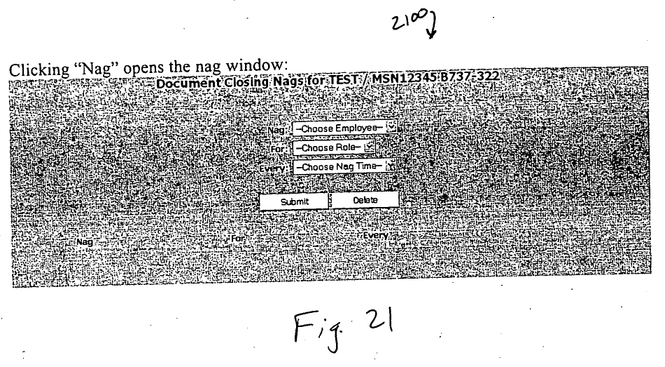

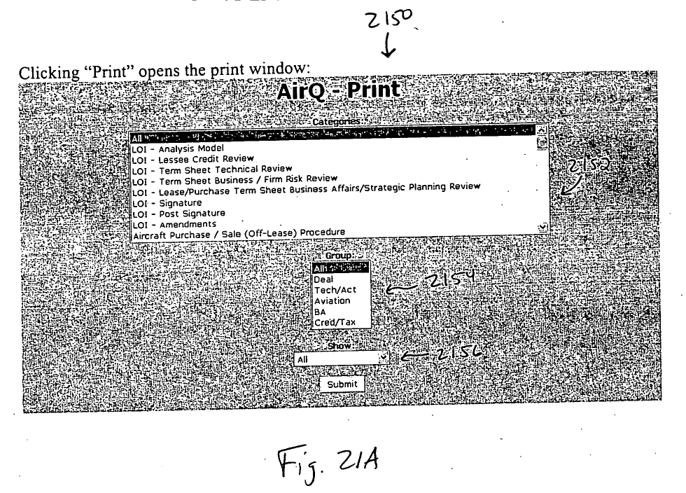

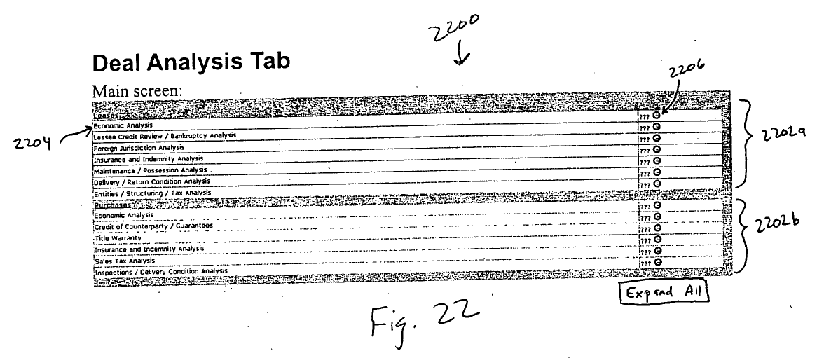

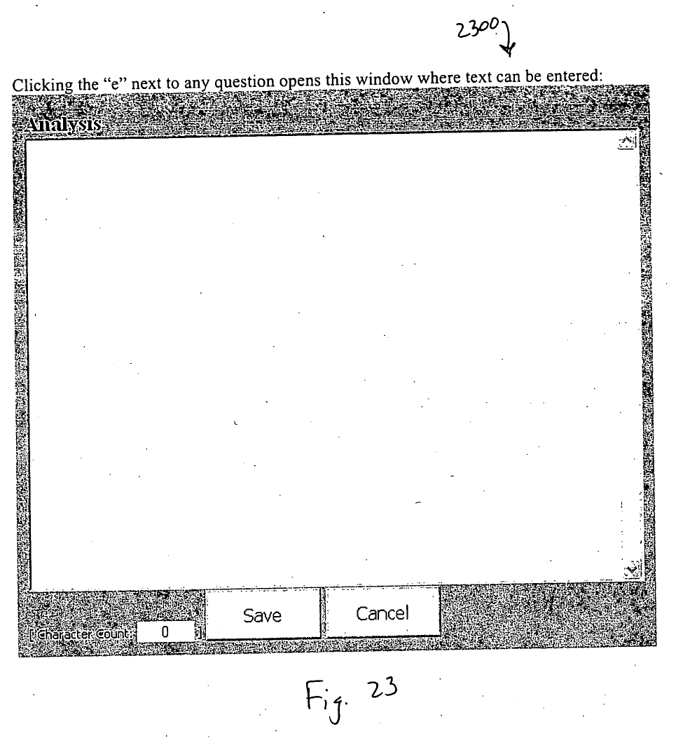

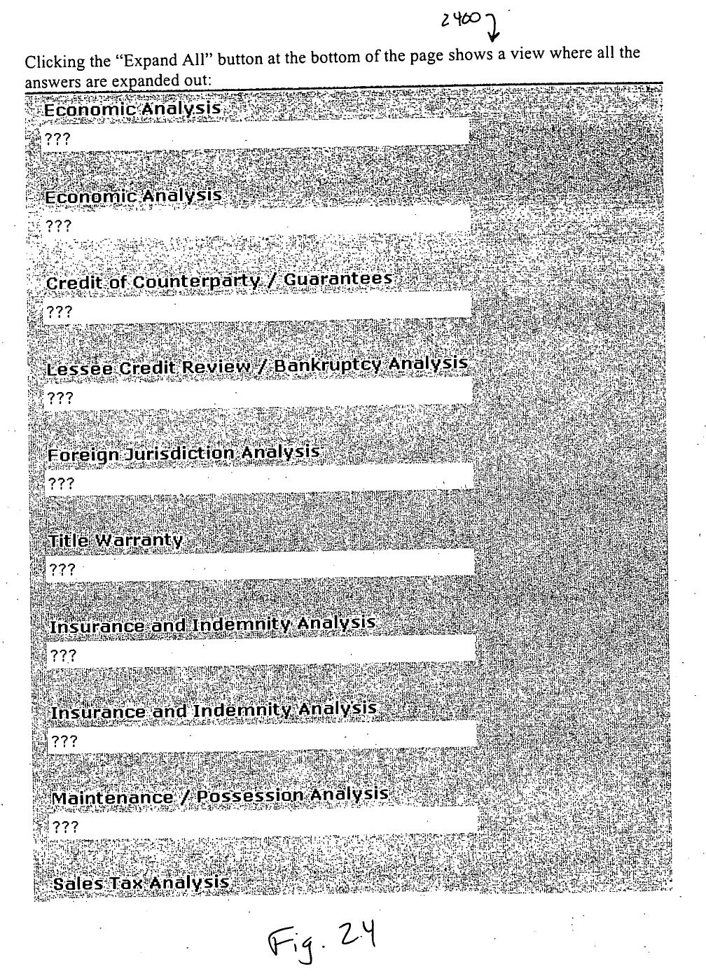

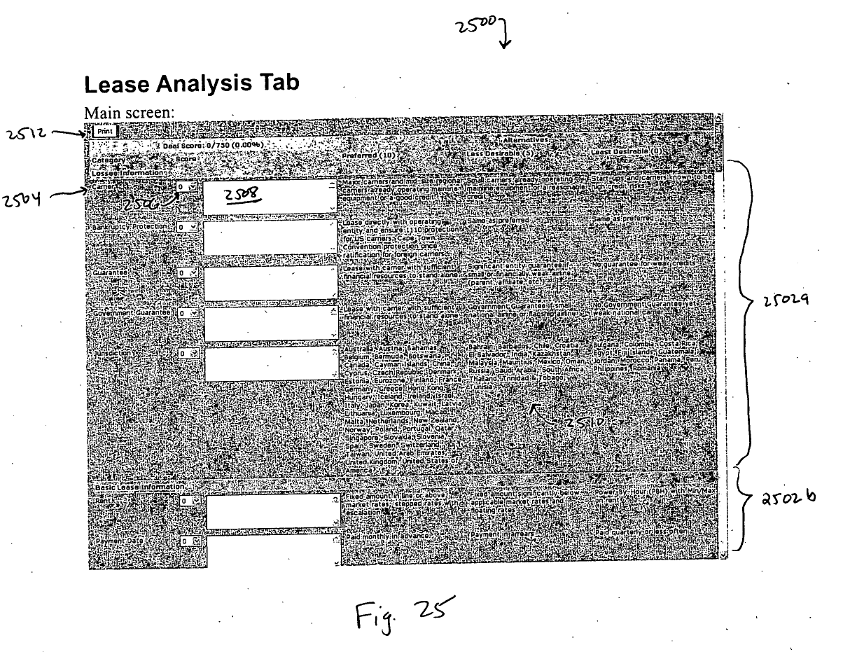

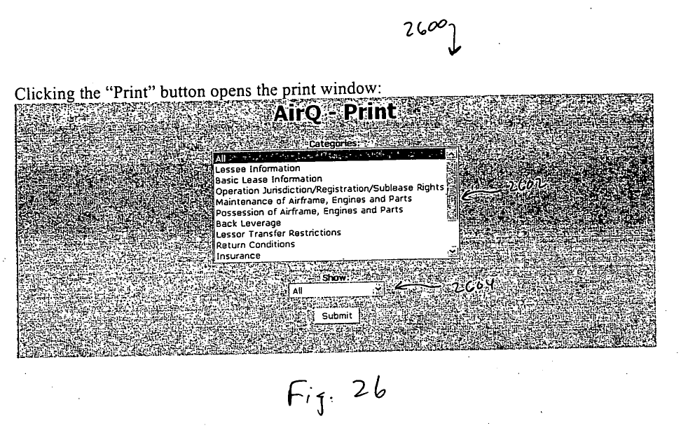

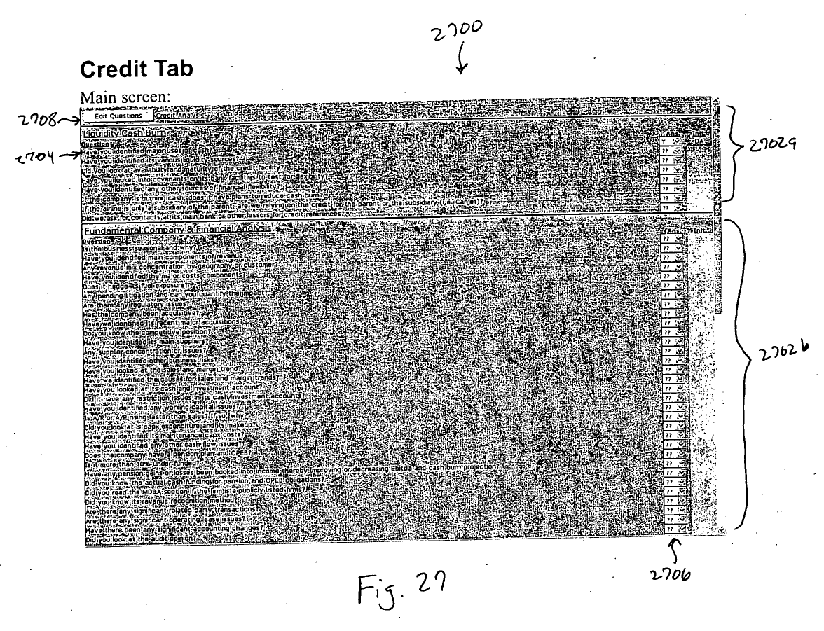

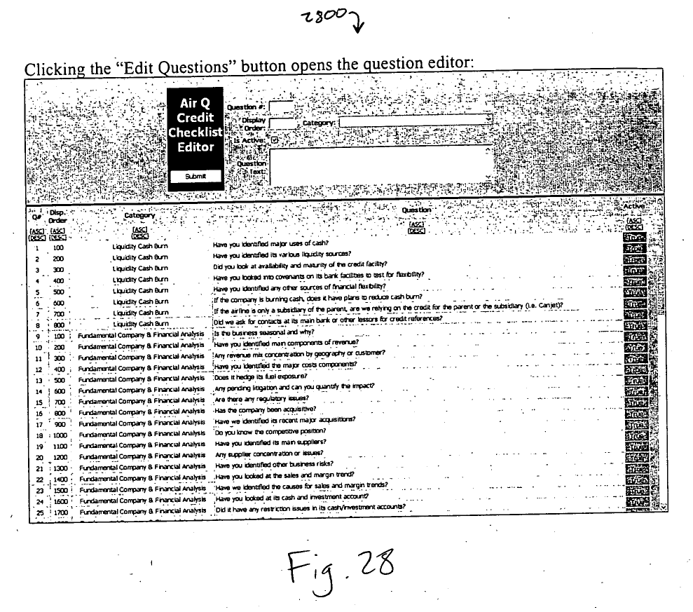

The transaction support server 106 includes any hardware, software, firmware, or combination thereof for supporting transactions involving aviation assets. In this example, the transaction support server 106 includes one or more processors 110 and one or more memories 112 containing data and instructions used by the one or more processors 110. The memories 112 could include, for example, one or more read-only memories (ROM), random access memories (RAM), magnetic storage media such as hard drives, and optical storage media such as CD or DVD drives. Also, the transaction support server 106 may receive input from users in any suitable manner. As a particular example, the transaction support server 106 may execute one or more applications that support a graphical user interface. One example of a graphical user interface is shown in FIGS. 2 through 42, which are described below.

The database 108 is coupled to the transaction support server 106. The database 108 stores various information used or collected by the transaction support server 106 to support transactions involving aviation assets. For example, the database 108 may include asset information 114, which generally represents any information associated with aviation assets. This could include, for example, an aircraft's registration number, registration country, manufacture date, engine type(s), and engine serial number(s). The database 108 may also include transaction information 116, which generally represents any information associated with transactions involving aviation assets. This could include, for example, the name of an entity leasing or buying an aircraft, the date of a lease or purchase agreement, a lease or purchase price, and a payment history.

The database 108 includes any hardware, software, firmware, or combination thereof for storing and facilitating retrieval of information. The database 108 may use any of a variety of data structures, arrangements, and compilations to store and facilitate retrieval of information. The division or organization of the information in the database 108 shown in FIG. 1 is for illustration only. The information in the database 108 could be arranged in any other suitable manner.

Although FIG. 1 illustrates one example of a system 100 for managing transactions involving aviation assets, various changes may be made to FIG. 1. For example, the system 100 may include any number of user devices, networks, servers, and databases. Also, while FIG. 1 illustrates that one database 108 is coupled directly to the transaction support server 106, any number of databases 108 may reside at any location or locations accessible by the server 106. In addition, while FIG. 1 illustrates the use of a server 106 in the system 100, the functionality of the server 106 could be implemented on other device(s). As particular examples, the transaction support functionality could be implemented as a stand-alone application executed by a desktop computer or a laptop computer.

FIGS. 2 through 42 illustrate an example graphical user interface 200 for managing transactions involving aviation assets in accordance with this disclosure. The graphical user interface 200 could, for example, be provided by an application executed by the transaction support server 106. This embodiment of the graphical user interface 200 is for illustration only. Other embodiments of the graphical user interface 200 may be used without departing from the scope of this disclosure.

As shown in FIG. 2, the graphical user interface 200 includes a summary section 202, a set of tabs 204, and a transaction information section 206. The summary section 202 generally identifies various information about an aircraft or other asset and a transaction. For example, the summary section 202 may identify a particular asset's unique identifier 208, registration number, registration country, manufacture date, owner trustee, owner participant, engine type, and engine serial number(s). The summary section 202 may also identify a particular transaction's unique identifier 210, a party to the transaction, a type of transaction, and a liability insurance minimum. The summary section 202 may further identify all of the aircraft identifiers 212 involved in a selected transaction or all of the transaction identifiers 214 associated with a selected aircraft. In addition, the summary section 202 includes general information about a transaction, such as a transaction's agreement date, expiration date, commencement date, rent amount, purchase price, and insurance renewal date.

In particular embodiments, values such as rent payment dates, insurance expiration dates, and other data may be retrieved from an external application. For example, the external application could represent SHAREPOINT, an intranet portal system from MICROSOFT CORPORATION, where relevant dates are entered into a calendar. The transaction support server 106 may locate any relevant calendar entries, extract the appropriate dates, and display the dates in the summary section 202 as links back to SHAREPOINT.

The tabs 204 allow a user to select different information for display in the transaction information section 206. For example, the tabs 204 allow the user to view various procedure checklists, information associated with a transaction (“deal”) analysis or lease analysis, or other information associated with a transaction. The transaction information section 206 generally provides a user with information about the procedures to be followed to complete a transaction, the requirements for a transaction, and other information associated with a transaction. The user can use the transaction information section 206 to indicate that various steps of a procedure have been completed, to confirm that various requirements have been satisfied, and to provide or review information regarding a transaction. The contents of the transaction information section 206 may vary based on which tab 204 is selected by the user and also the type of transaction (lease, sale, and the like).

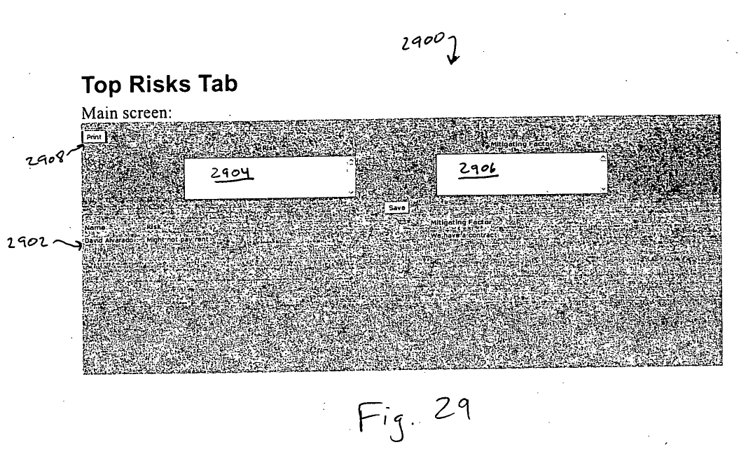

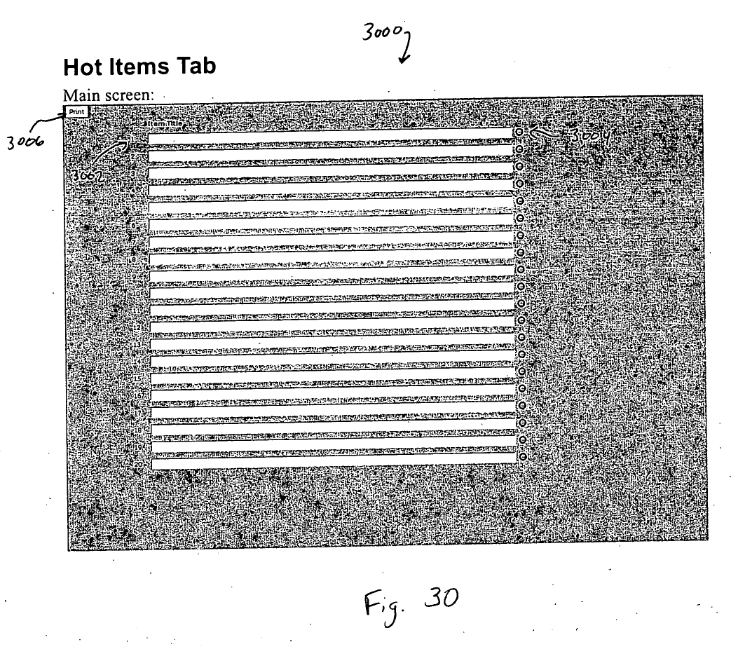

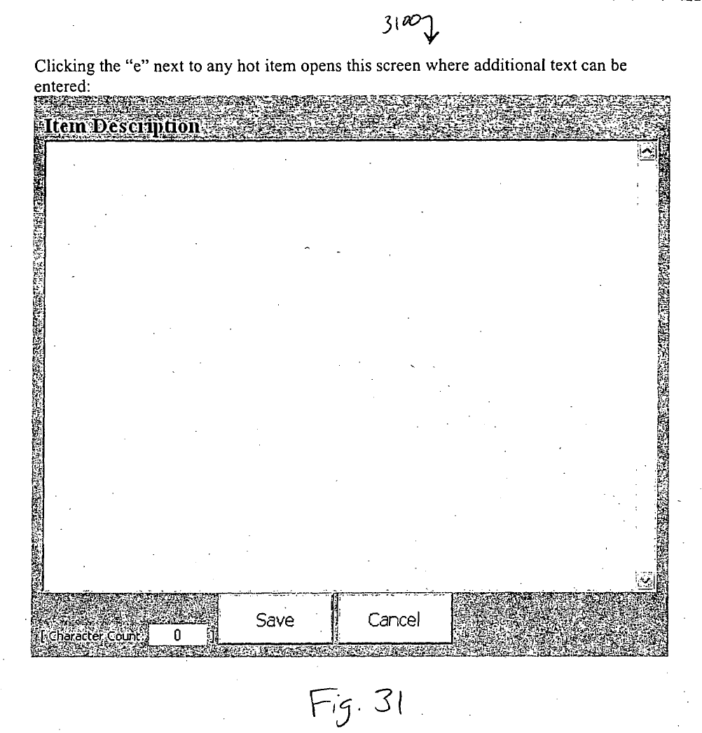

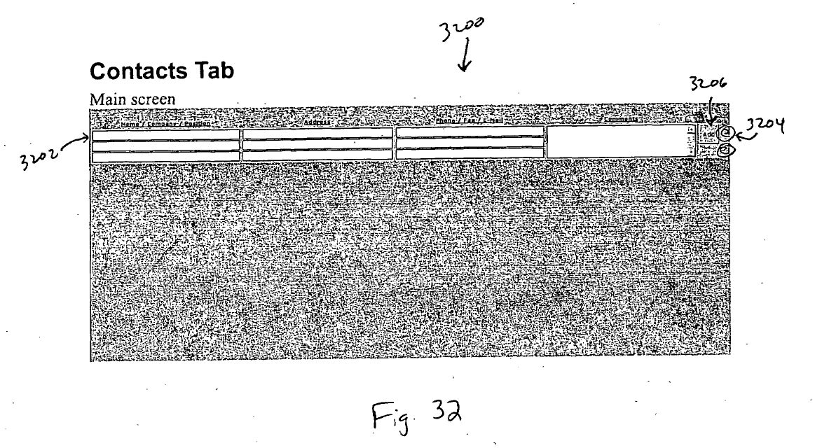

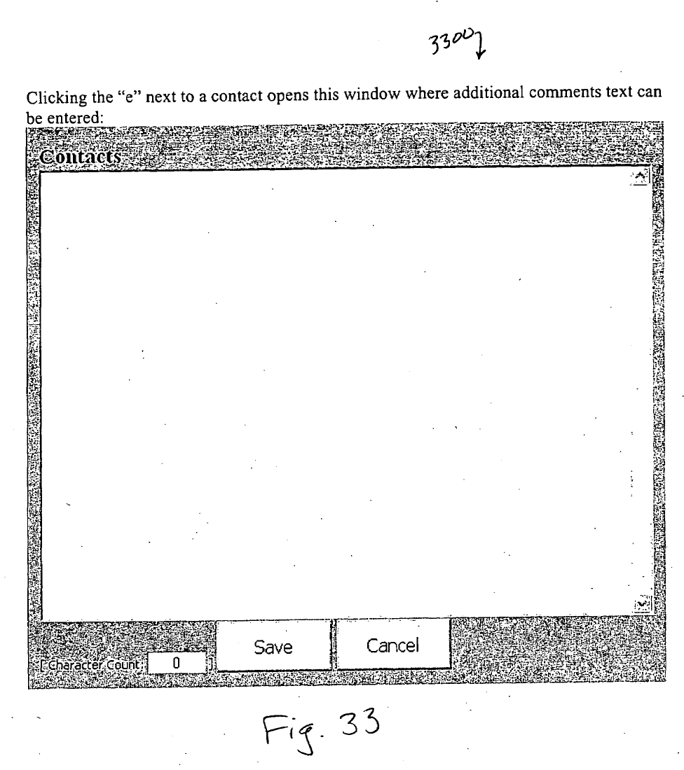

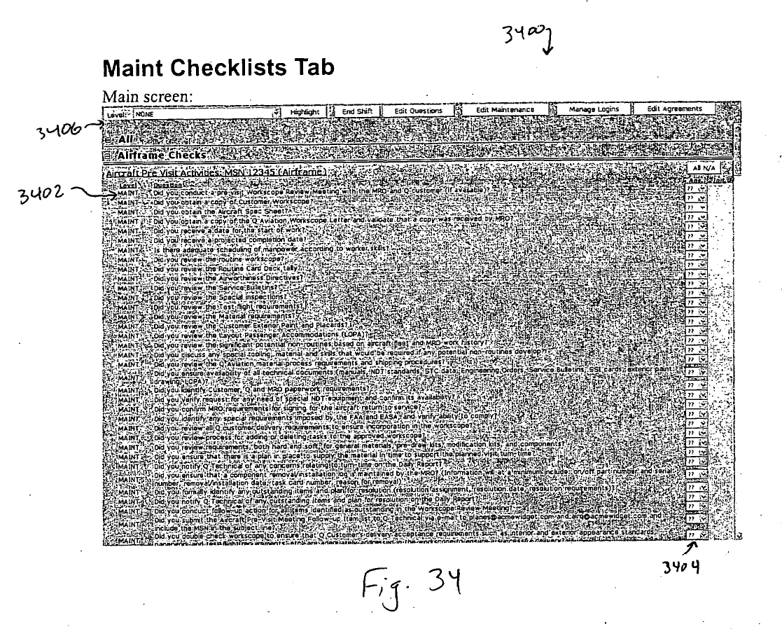

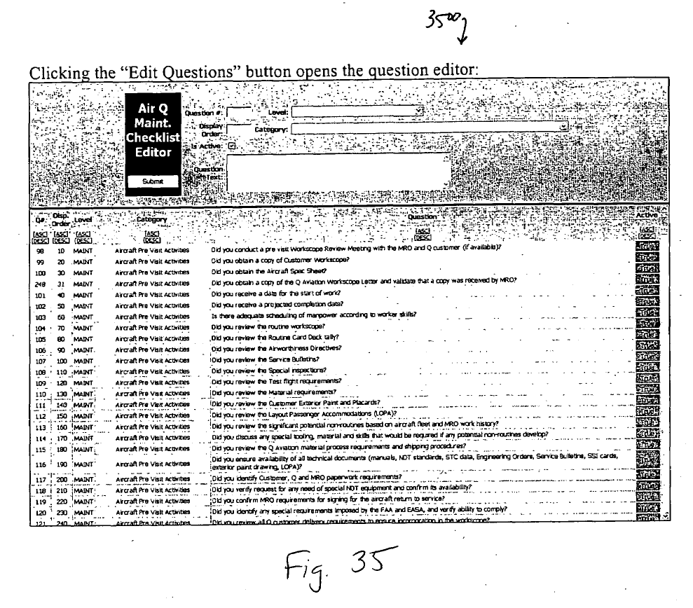

A user can select a particular aircraft or other asset by selecting the box containing the asset identifier 208 in FIG. 2, such as by using a mouse to click on the box. This could present the user with an asset selection window 300 as shown in FIG. 3. The asset selection window 300 includes a list 302 of the various aircraft, aircraft components (such as engines), or other assets that can be selected by a user. Selection of a particular asset from the list 302 causes information associated with that asset to be displayed in the summary section 202. The asset selection window 300 also includes a search section 304, which allows the user to search for a particular asset or assets satisfying the user's search criteria or to otherwise narrow the list 302.

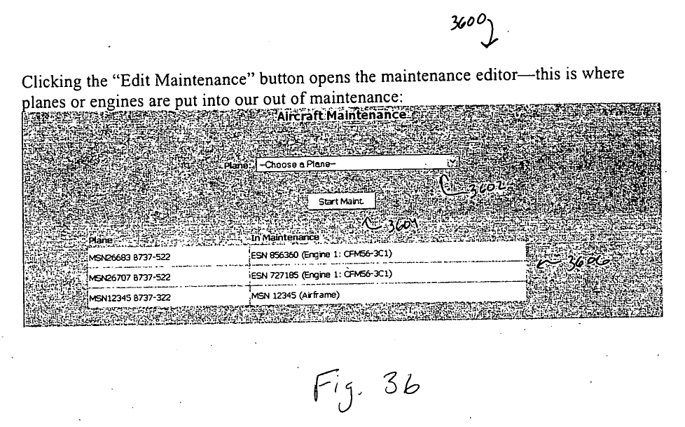

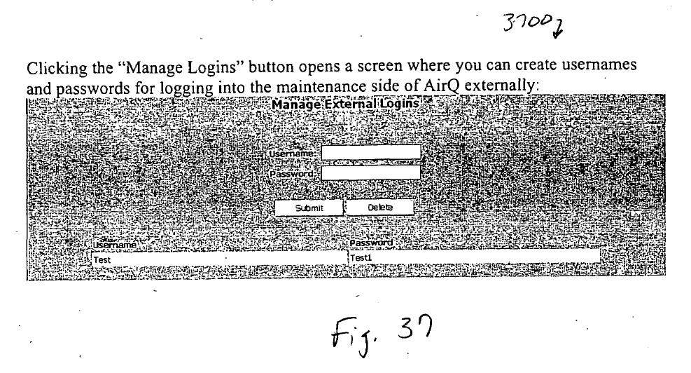

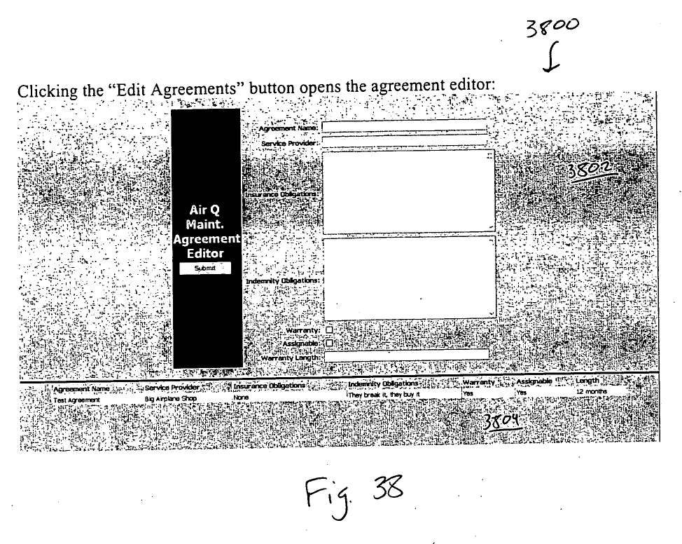

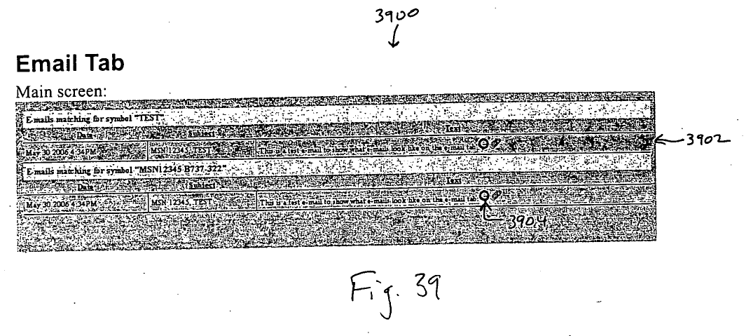

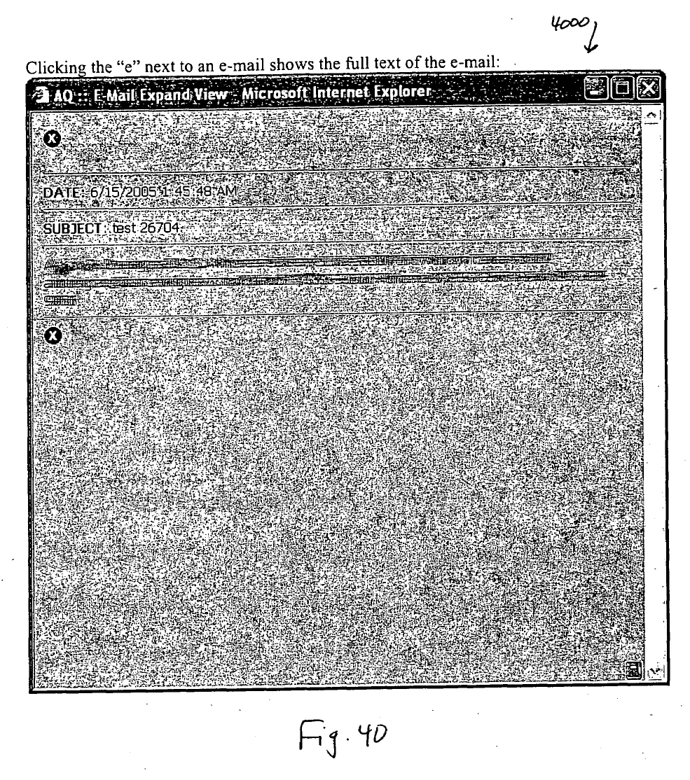

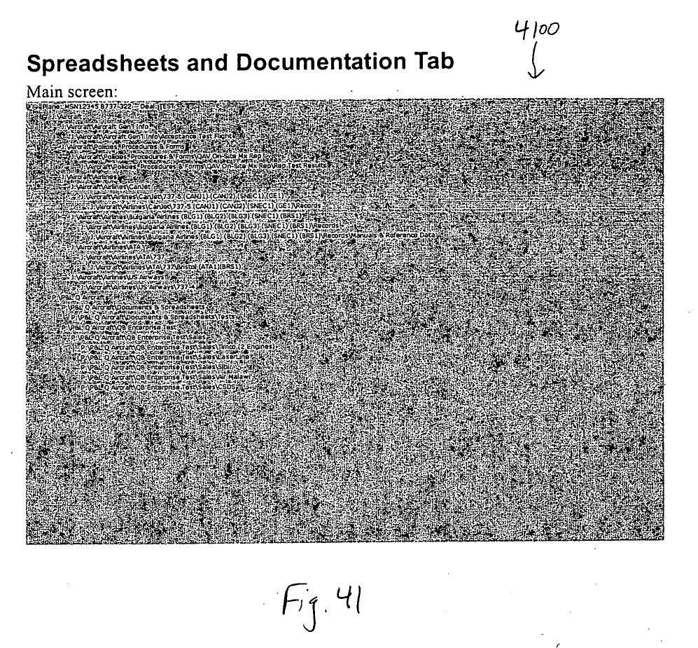

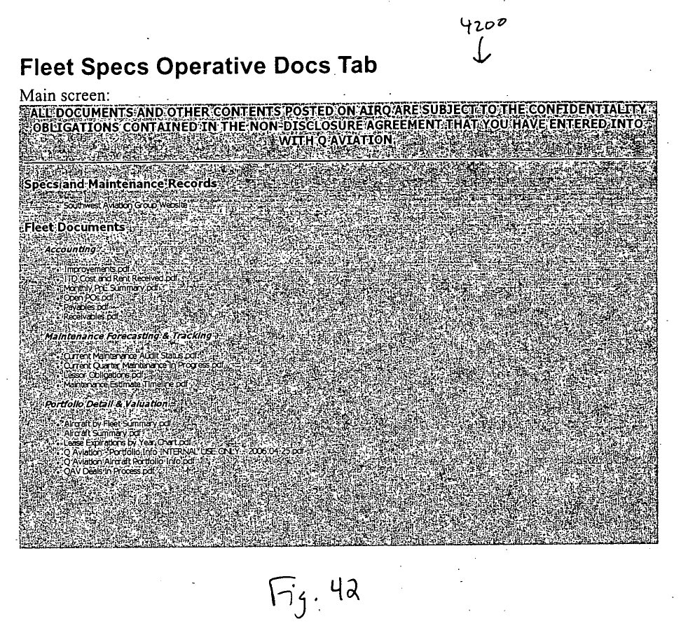

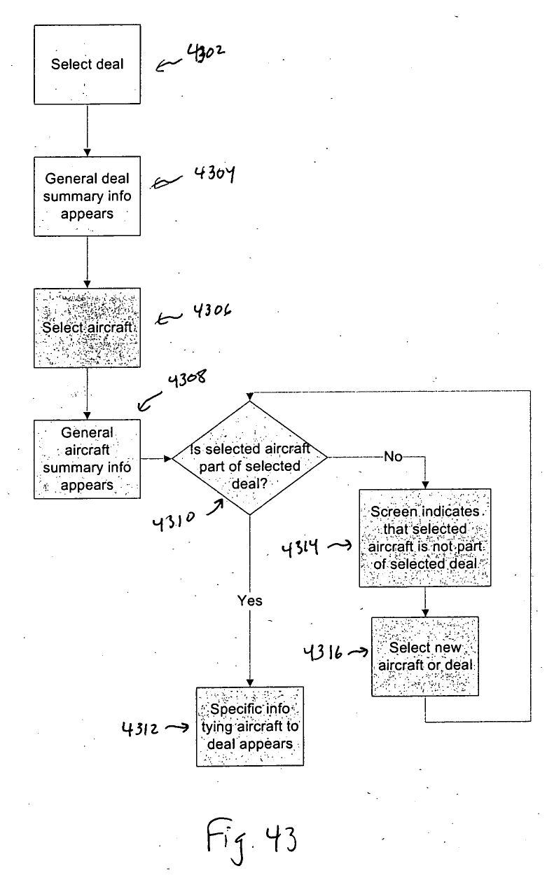

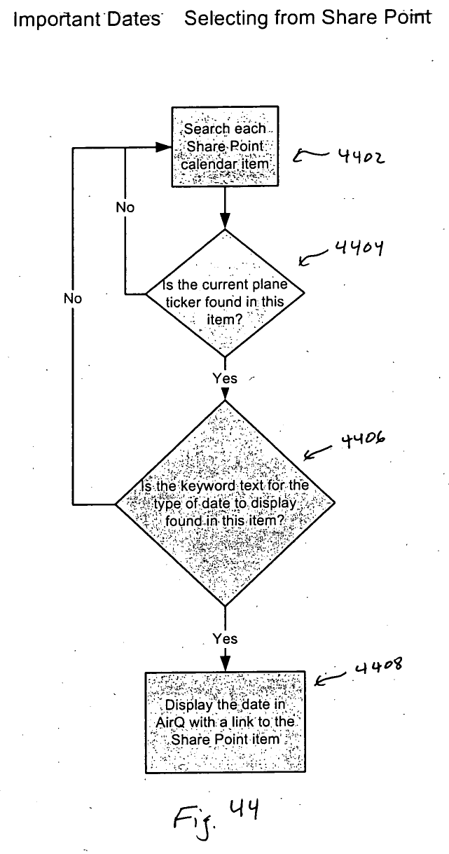

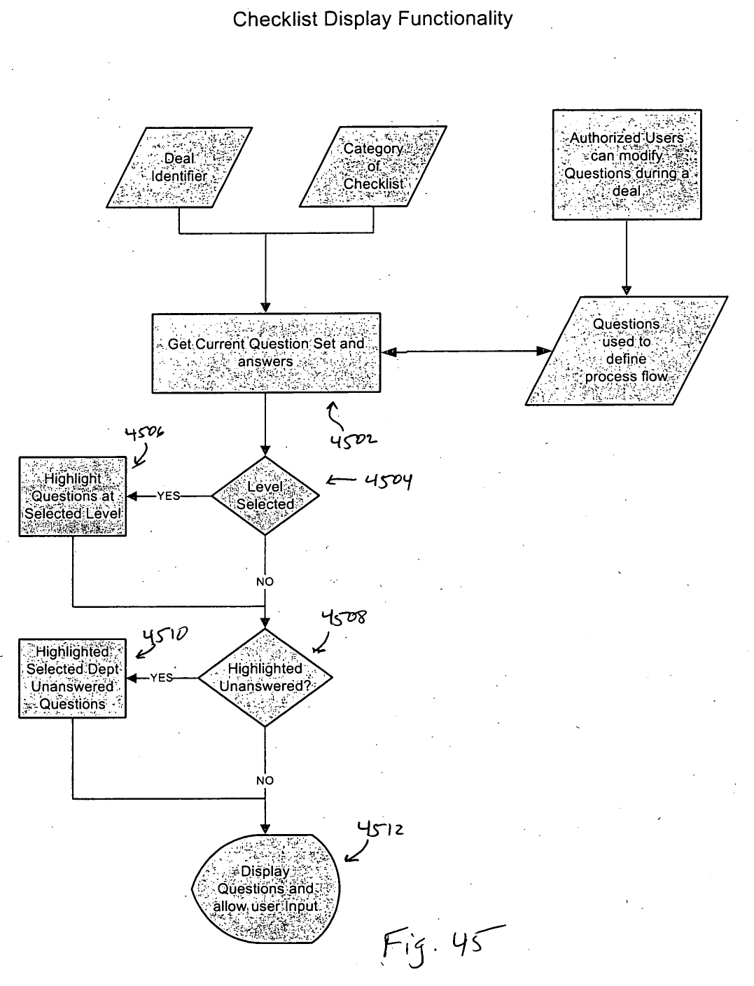

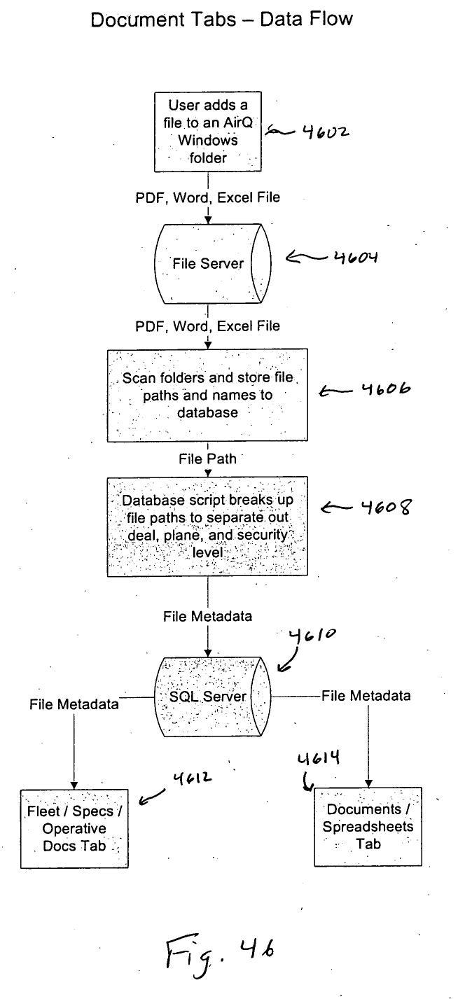

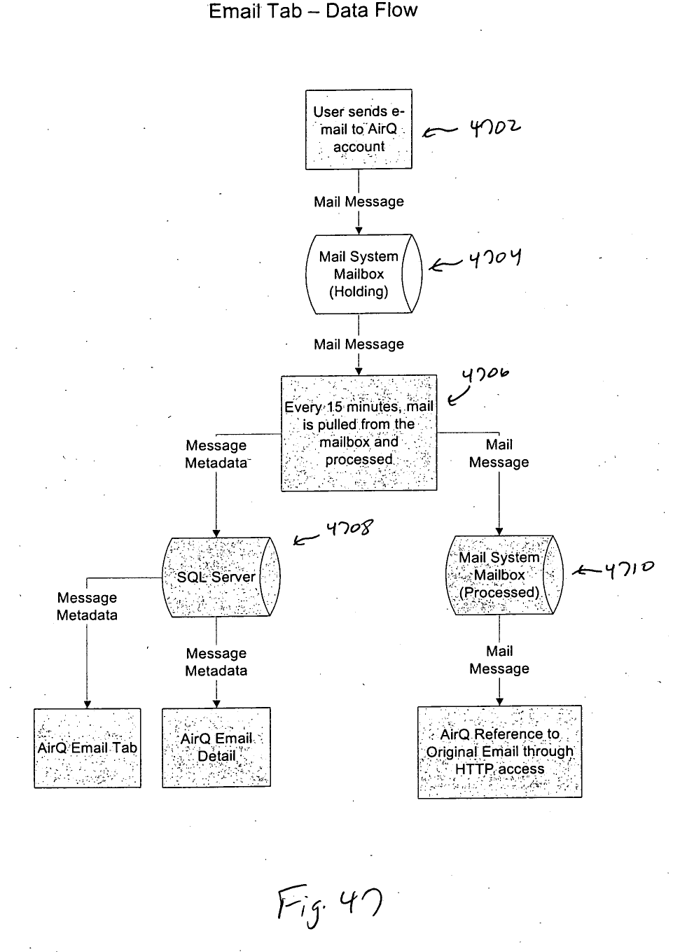

The user could also edit the information associated with a selected asset by selecting the “edit” link next to the box containing the asset identifier 208 in FIG. 2. This could present the user with an asset edit window 400 as shown in FIG. 4. The asset edit window 400 includes a data entry section 402, which allows the user to add or edit information associated with a particular asset. The asset edit window 400 also includes an asset list 404, which allows a user to select a particular asset. Selection of an asset in the asset list 404 may cause information associated with that asset to be displayed in the data entry section 402, allowing the user to edit that information.

In a similar manner, the user can select a transaction for display in the summary section 202. For example, the user could select a particular transaction by selecting the box containing the transaction identifier 210 in FIG. 2. This could present the user with a transaction selection window 500 as shown in FIG. 5. The transaction selection window 500 includes a list 502 of transactions that can be selected by the user. Selection of a particular transaction in the list 502 causes information associated with the transaction to be displayed in the summary section 202. The transaction window 500 also includes a search section 504, which allows the user to search for a particular transaction or transactions or to otherwise narrow the list 502.

The user can also edit information associated with a selected transaction by selecting the “edit” link next to the box containing the transaction identifier 210 in FIG. 2. This could present the user with a transaction edit window 600 as shown in FIG. 6. The transaction edit window 600 includes a data entry section 602, which allows a user to add or edit information associated with a particular transaction. The transaction edit window 600 also includes a transaction list 604, where selection of a particular transaction in the list 604 causes information associated with that transaction to be displayed in the data entry section 602 for editing.

As noted above, the summary section 202 may identify the serial number(s) of one or more engines associated with a particular asset. The user could select the serial number of an engine (such as by clicking on the serial number) to view an engine summary window 700 as shown in FIG. 7. The engine summary window 700 identifies a brief history of a particular engine. In this example, the history includes a purchase date and an identification of the aircraft that the engine was purchased with (the aircraft identification represents a link to the aircraft's information). The history also identifies the transaction in which the engine was purchased and any comments associated with the engine.

The engine summary window 700 also includes a “Manage Engine Swaps” link 702, which allows a user to view information associated with “engine swaps.” Engine swaps identify replacements or exchanges of aircraft engines. For example, an engine on an aircraft may be damaged and require replacement. As another example, an engine on an aircraft about to be leased may be exchanged with an engine on a different aircraft. Selection of the link 702 may present the user with an engine history edit window 800 as shown in FIG. 8. The engine history edit window 800 includes a data entry section 802, which allows the user to add or edit information associated with a particular engine swap. The engine history edit window 800 also includes an engine swap list 804, which allows a user to select a particular engine swap.

As shown in FIG. 2, the user is further given the option of editing general information displayed in the summary section 202 by selecting the “edit deal+aircraft info” link. Selection of this link presents an edit window 900, which is shown in FIG. 9. The edit window 900 allows the user to modify various information about an asset or a transaction, such as an agreement data, expiration date, rent amount, or total asset cost.

As noted above, the user may select different tabs 204 to view different information about a transaction in the transaction information section 206. For example, selection of the “Procedure Checklists” tab 204 may present procedure checklist information 1000, shown in FIG. 10, in the transaction information section 206 of the graphical user interface 200. As shown in FIG. 10, the procedure checklist information 1000 is divided into multiple categories (including categories 1002a-1002e). Each category includes one or more entries 1004 and is generally associated with a different overall task or function in a procedure. Each entry 1004 is associated with a different step of an overall task or function. For example, the category 1002a is associated with an analysis of the financial model for a potential transaction, and the category 1002d is associated with a review of the risks associated with a potential transaction.

For each entry 1004, there are one or more drop-down menus 1006 allowing one or more users to answer a question associated with that entry 1004. For example, the drop-down menu 1008 has been set to a value of “Y” to indicate that a user notified the appropriate persons when a potential transaction became serious. The drop-down menu 1008 is also associated with the initials of the user who selected the “Y” value in the drop-down menu 1008. This allows both the tracking of various steps during a procedure as well as the user(s) who complete the steps. In some embodiments, each drop-down menu 1006 may include three possible values, namely “Y” (indicating a step has been completed or approved), “N” (indicating a step has not been completed or approved), and “N/A” (indicating a step is not applicable to a particular transaction). A “??” value could be displayed whenever no selection has been made for a particular drop-down menu 1006. Also, an “All N/A” button could be used to set all drop-down menus 1006 in a particular category to the “N/A” value if they are not applicable for a particular transaction.

In this example, the drop-down menus 1006 are divided into different columns, which are associated with different user roles. These roles identify different types of users who need to sign off on a particular entry 1004 before the entry 1004 is considered to be complete. In this example, the columns identify whether an entry 1004 requires sign off from a user who is leading a deal (“Deal”), a user from a technical or accounting group (“Tech/Act”), a user from an aviation group (“Aviation”), a user from a business affairs group (“BA”), and a user from a credit or tax group (“Cred/Tax”). In other words, the roles represent users having different areas of responsibility or expertise.

As shown in FIG. 10, various controls 1010 are provided for performing various functions. For example, different visual identifiers can be added to the procedures checklist information 1000 using the controls 1010. In this example, the controls 1010 allow a user to select a particular “level” from a drop-down menu, and the user can select a “Highlight” button to highlight the entries 1004 associated with that level. The highlighting could, for example, involve changing the background color of the appropriate entries 1004. In general, “levels” are associated with different types of transactions, and the entries 1004 for a particular transaction type are associated with the same level. The highlighting therefore allows the entries 1004 associated with a relevant transaction type to be easily identified. Similarly, the controls 1010 allow the user to select and highlight all of the answered or unanswered entries 1004 in the procedures checklist information 1000. This highlighting could, for example, involve changing the background color of the unanswered drop-down menus 1006 to a different color than the previous highlighting. In other embodiments, the highlighting could be replaced, for example, by displaying only the entries 1004 in the transaction information section 206 associated with a selected level or displaying only unanswered questions (and omitting all other entries 1004).

The controls 1010 further allow the user to edit the questions, categories, and levels. This could be allowed only for users having the appropriate authorization or security level in the system 100. Selection of the “Edit Questions” button in the controls 1010 may present the user with a question edit window 1100 as shown in FIG. 11. The question edit window 1100 includes a data entry section 1102 and a question list 1104. The data entry section 1102 allows the user to add or edit a question, and the question list 1104 allows the user to view existing questions and to select a particular question for editing. Among other things, the user could edit the wording of a question, associate a question with a different level or category, indicate whether a question is active (if it should be displayed in the transaction information section 206), and which signoffs are required for a question.

Selection of the “Edit Categories” button in the controls 1010 may present the user with a category edit window 1200 as shown in FIG. 12. The category edit window 1200 includes a data entry section 1202 and a category list 1204. The data entry section 1202 allows the user to add or edit a category, and the category list 1204 allows the user to view existing categories and to select a particular category for editing. In this example, the user could edit the name of a category and the order that categories are displayed in the transaction information section 206.

Selection of the “Edit Levels” button in the controls 1010 may present the user with a level edit window 1300 as shown in FIG. 13. The level edit window 1300 includes a data entry section 1302 and a level list 1304. The data entry section 1302 allows the user to add or edit a level, and the level list 1304 allows the user to view existing levels and to select a particular level for editing. In this example, the user could edit the identifier associated with a level and a description of a level.

The user could also select a “Print” button in the controls 1010 to print the procedures checklist information 1000. In addition, the user can select a “View All Nags” button in the controls 1010, which may present the user with a reminder window 1400 as shown in FIG. 14. In some embodiments, a reminder or “nag” can be established to remind or inform a user that he or she needs to sign off on or perform an action associated with an entry 1004. For example, a particular user may need to sign off on an entry 1004 before the next step in a procedure can begin, and a one-time or repeating reminder can be established to send reminders to that particular user. A reminder could represent an email message, an instant message, an automated telephone call, or any other type of reminder. The user using the graphical user interface 200 can select the “View All Nags” button to view all of the reminders sent to that user.

Selection of the “View All Nags” button may present the user with a reminder window 1400 as shown in FIG. 14. In this example, the reminder window 1400 identifies, for each reminder, the transaction, question category, and question (entry 1004) that requires the user's attention. The reminder window 1400 may also identify the user who created the reminder, the role of the user receiving the reminder, the interval of time for a repeating reminder, the time the reminder was created, the number of times a repeating reminder has been sent, and whether the reminder is currently active.

A reminder can be created by selecting the question in a particular entry 1004, which may present the user with a reminder creation window 1500 as shown in FIG. 15. The reminder creation window 1500 allows the user to identify the target of the reminder being created, the role of the target, and the time interval between repeating reminders.

Selection of the “Document Closing” tab 204 in the graphical user interface 200 may present document closing checklist information 1600, shown in FIG. 16, in the transaction information section 206. As shown in FIG. 16, the document closing checklist information 1600 is divided into multiple categories (including categories 1602a-1602e). Each category includes one or more entries 1604 and is generally associated with a different overall task or function related to preparing closing documents for a transaction. Each entry 1604 is associated with a different step of an overall task or function. For example, the category 1602a is associated with confirming that different terms of a transaction (such as terms dealing with price, warranties, liabilities, and risks) are acceptable. The category 1602e is associated with confirming that various miscellaneous terms (such as jurisdiction and termination rights) are acceptable.

For each entry 1604, there are one or more drop-down menus 1606 allowing one or more users to answer a question associated with that entry 1604. For example, the drop-down menus 1606 can be used by users in different user roles to accept or reject proposed terms of a transaction. Each drop-down menu 1606 could, for example, be set to “Y” to accept a term, “N” to reject a term, or “N/A” to indicate that the question in an entry 1604 is not applicable to a transaction. An “All N/A” button could be used to set all drop-down menus 1606 in a particular category to the “N/A” value.

As shown in FIG. 16, various controls 1608 are provided. For example, the controls 1608 allow the user to highlight entries 1604 associated with a particular level. The controls 1608 also allow the user to highlight answered or unanswered entries 1604 in the document closing checklist information 1600, such as by highlighting the answered or unanswered drop-down menus 1606.

The controls 1608 further allow the user to edit the questions, categories, and levels. Selection of the “Edit Questions” button in the controls 1608 may present the user with a question edit window 1700 as shown in FIG. 17, which may be the same as or similar to the question edit window 1100 of FIG. 11. Selection of the “Edit Categories” button in the controls 1608 may present the user with a category edit window 1800 as shown in FIG. 18, which may be the same as or similar to the category edit window 1200 of FIG. 12. Selection of the “Edit Levels” button in the controls 1608 may present the user with a level edit window 1900 as shown in FIG. 19, which may be the same as or similar to the level edit window 1300 of FIG. 13. The user could also select a “Print” button in the controls 1608 to print the document closing checklist information 1600.

Beyond that, the user could select a “Copy” button in the controls 1608, which may present the user with a copy window 2000 as shown in FIG. 20. The copy window 2000 allows answers from the current transaction to be copied into the document closing checklist information 1600 for a different transaction. In this example, the copy window 2000 includes drop-down menus allowing the user to identify a transaction and a user role, where answers from the current transaction are copied into the identified user role for the identified transaction.

The user can further select a “View All Nags” button in the controls 1608 to view the reminder window 1400 of FIG. 14, or the user could select a “Nag” button in the controls 1608 to view a reminder creation window 2100 as shown in FIG. 21. The reminder creation window 2100 allows the user to create a reminder for another user, which may be done in the same or similar manner as discussed above with respect to FIG. 15.

In addition, the user can select a “Print” button in the controls 1608 to view a print window 2150 as shown in FIG. 21A. Using a list 2152, the user may choose to print the contents from one or more particular categories (including categories 1602a-1602e) or from all categories. Using a list 2154, the user can also select the questions (entries 1604) requiring a sign off from one, some, or all of the user roles in the document closing checklist information 1600. Using a drop-down menu 2156, the user can further select which fields of the selected category or categories to print.

Selection of the “Deal Analysis” tab 204 in the graphical user interface 200 may present deal analysis checklist information 2200, shown in FIG. 22, in the transaction information section 206. As shown in FIG. 22, the deal analysis checklist information 2200 is divided into multiple categories (including categories 2202a-2202b), each of which includes one or more entries 2204. The categories are generally associated with analyses related to different types of transactions. For example, the category 2202a identifies the analyses typically needed for lease transactions, and the category 2202b identifies the analyses typically needed for purchase transactions. Each entry 2204 identifies a different type of analysis to be performed.

In this example, each entry 2204 is associated with an expand or “e” button 2206. Selecting the expand button 2206 for any entry 2204 may present a data entry window 2300 as shown in FIG. 23. The data entry window 2300 represents a data entry mechanism allowing the user to review or provide free-form text for a particular analysis. In some embodiments, the data entry window 2300 may count the number of characters entered by the user and limit the number of characters to a maximum amount. Selection of an “Expand All” button in FIG. 22 may present a data entry window 2400 as shown in FIG. 24. The data entry window 2400 may allow the user to review or provide text for all of the different analyses (entries 2204).

Selection of the “Lease Analysis” tab 204 in the graphical user interface 200 may present lease analysis checklist information 2500, shown in FIG. 25, in the transaction information section 206. As shown in FIG. 25, the lease analysis checklist information 2500 is divided into multiple categories (including categories 2502a-2502b), each of which includes one or more entries 2504. Each of the categories is generally associated with analyses related to different aspects of a lease. For example, the category 2502a identifies analyses related to the leasing party in a lease (i.e. the “lessee”), and the category 2502b identifies analyses related to the actual terms of a lease.

In this example, each entry 2504 includes a drop-down menu 2506, which is used to identify a “score” or the results of an analysis. For example, higher scores could correspond to more favorable lessee characteristics or lease terms, while lower scores could correspond to less favorable lessee characteristics or lease terms. Each entry 2504 also includes a text box 2508, which allows for free-form text entry by the user. In addition, each entry 2504 includes possible lease terms 2510 divided into preferred, less desirable, and least desirable terms. These lease terms 2510 could, for example, be used in the actual transaction being analyzed or form the basis for scoring the transaction being analyzed.

If the user selects a “Print” button 2512, a print window 2600 may be presented as shown in FIG. 26. Using a list 2602, the user may choose to print the contents from one or more particular categories (including categories 2502a-2502b) or from all categories. Using a drop-down menu 2604, the user can also select which fields of the selected category or categories to print.

Selection of the “Credit” tab 204 in the graphical user interface 200 may present credit checklist information 2700, shown in FIG. 27, in the transaction information section 206. As shown in FIG. 27, the credit checklist information 2700 is divided into multiple categories (including categories 2702a-2702b), each of which includes one or more entries 2704. Each of the categories is generally associated with different financial aspects of a transaction. For example, the category 2702a identifies different functions or tasks related to analyzing the cash liquidity of a party to a potential transaction. The category 2702b identifies different functions or tasks related to financially analyzing the party to a potential transaction.

In this example, each entry 2704 includes a drop-down menu 2706, which can be used to identify the answer to a question associated with that entry 2704. Also, various controls 2708 are provided to the user. For example, selection of an “Edit Questions” button in the controls 2708 could present the user with a question edit window 2800 as shown in FIG. 28, which could function in the same or similar manner as the question edit windows 1100 and 1700. The user could also select a “Credit Analysis” link in the controls 2708, which would allow the user to view a credit analysis of a party to a potential transaction.

Selection of the “Top Risks” tab 204 in the graphical user interface 200 may present risk information 2900, shown in FIG. 29, in the transaction information section 206. As shown in FIG. 29, the risk information 2900 includes one or more entries 2902. Each entry 2902 identifies a potential risk associated with a transaction and any mitigating factors associated with that risk. Two free-form text boxes 2904 and 2906 are provided to allow the user to identify a risk and its associated mitigating factors (if any). Also, a “Print” button 2908 can be selected by the user to print the risk information 2900.

Selection of the “Hot Items” tab 204 in the graphical user interface 200 may present hot item information 3000, shown in FIG. 30, in the transaction information section 206. As shown in FIG. 30, the hot item information 3000 identifies any important issues associated with a transaction. These important issues or “hot items” could represent any suitable issue(s), such as a potential problem with a transaction or a contract term change that can be requested if an opportunity to renegotiate a contract occurs. In this example, the hot item information 3000 includes multiple entries 3002, each of which can identify an issue. Each entry 3002 is associated with an expand or “e” button 3004, which may be selected to present a data entry window 3100 as shown in FIG. 31. The user could use the data entry window 3100 to review or provide free-form text describing an issue with a transaction. In addition, the user can select a “Print” button 3006 to print the hot item information 3000.

Selection of the “Contacts” tab 204 in the graphical user interface 200 may present contact information 3200, shown in FIG. 32, in the transaction information section 206. As shown in FIG. 32, the contact information 3200 identifies one or more parties or contacts associated with a transaction. In this example, the contact information 3200 includes multiple entries 3202. Each entry 3202 identifies various information associated with a contact, such as a name of a person, a company associated with the person, and that person's position in the company. Each entry 3202 may also identify an address, telephone number, fax number, and email address, as well as any additional comments. An expand or “e” button 3204 can be selected to present a data entry window 3300 as shown in FIG. 33, which allows the user to provide additional information about a contact. In addition, an “Add” button 3206 can be used to add an entry 3202.

Selection of the “Maintenance Checklists” tab 204 in the graphical user interface 200 may present maintenance checklist information 3400, shown in FIG. 34, in the transaction information section 206. As shown in FIG. 34, the maintenance checklist information 3400 is divided into multiple categories (one of which is shown in FIG. 34). Each of the categories is generally associated with tasks or functions (identified by entries 3402) related to different types of maintenance associated with an aviation asset.

For each entry 3402, there is a drop-down menu 3404 indicating whether a particular maintenance task or function has been completed. Each drop-down menu 3404 could, for example, be set to a value of “Y” to indicate that a task or function has been performed, “N” to indicate that a task or function has not been performed, or “N/A” to indicate that a task or function is not applicable to a transaction. An “All N/A” button could be used to set all drop-down menus 3404 in a particular category to the “N/A” value.

As shown in FIG. 34, various controls 3406 are provided. For example, the controls 3406 may allow the user to highlight entries associated with a particular level. An “End Shift” button in the controls 3406 may be selected by the user to manually indicate that a maintenance shift has ended. An “Edit Questions” button in the controls 3406 may present an edit question window 3500 as shown in FIG. 35, which allows the user to edit the questions in the entries 3402.

An “Edit Maintenance” button in the controls 3406 may present a maintenance edit window 3600 as shown in FIG. 3600. The maintenance edit window 3600 allows the user to indicate whether an aviation asset is currently undergoing maintenance. In this example, the user may select an aviation asset from a drop-down menu 3602. Once the appropriate asset is selected, the user may select a “Start Maintenance” button 3604 to indicate that the selected asset is undergoing maintenance. In addition, a list 3606 is provided to identify the assets currently undergoing maintenance.

A “Manage Logins” button in the controls 3406 may present a login management window 3700 as shown in FIG. 37. The login management window 3700 may allow the user to create, modify, and delete username/password accounts. These accounts can be used by external personnel, such as maintenance consultants, to access information associated with an asset.

An “Edit Agreements” button in the controls 3406 may present an agreement edit window 3800 as shown in FIG. 38. The agreement edit window 3800 allows the user to view and modify information associated with maintenance agreements. In this example, the agreement edit window 3800 includes a data entry section 3802 for entering and modifying maintenance agreement information. The agreement edit window 3800 also includes an agreement list 3804 for selecting an existing agreement. In the data entry section 3802, the user may provide information such as the service provider to provide maintenance, insurance and indemnity obligations associated with a maintenance agreement, whether the maintenance agreement is for warranty work or is assignable, and a length of any warranty.

Selection of the “Email” tab 204 in the graphical user interface 200 may present email information 3900, shown in FIG. 39, in the transaction information section 206. As shown in FIG. 39, the email information 3900 includes one or more entries 3902, each of which is associated with an email message related to a transaction. In this example, each entry 3902 includes the date, partial or complete subject, and partial or complete text of an email message. Selection of an expand or “e” button 3904 in an entry 3902 may present an email window 4000 as shown in FIG. 40. The email window 4000 contains the entire email message associated with an entry 3902.

In some embodiments, the emails in the email information 3900 is generated automatically by the transaction support server 106. For example, a user who is sending an email may wish to log the email in the email information 3900. In this case, the user could send, carbon copy, or blind copy the email message to a particular email address (such as “@q.com”) and include a transaction identifier. The transaction support server 106 could receive the email message and use the transaction identifier to log the email message in the appropriate transaction's email information 3900. Any other or additional technique could be used to associate email messages and transactions.

Selection of the “Spreadsheets and Documentation” tab 204 in the graphical user interface 200 may present a related document index 4100, shown in FIG. 41, in the transaction information section 206. As shown in FIG. 41, the related document index 4100 identifies one or more spreadsheets and other documents related to a transaction. The related documents could contain any suitable information, such as general information for an aviation asset, test results, or maintenance records. In some embodiments, each identified document in the related document index 4100 could represent a link that can be selected to view a related document.

Selection of the “Fleet/Specs/Operative Documents” tab 204 in the graphical user interface 200 may present a document index 4200, shown in FIG. 42, in the transaction information section 206. As shown in FIG. 42, the document index 4200 identifies one or more documents associated with a fleet of aircraft (such as from an air carrier like SOUTHWEST AIRLINES). These documents could include specifications and maintenance records, accounting documents, maintenance forecasts, maintenance tracking documents, lease agreements, purchase agreements, and other transaction documents. These documents could also include portfolio detail and valuation documents related to a fleet of aircraft. Again, each identified document in the document index 4200 could represent a link that can be selected to view a related document.

The preceding description and related figures have described a particular graphical user interface 200 that can be used for managing transactions involving aviation assets. This represents only one of many possible implementations of the graphical user interface 200. Various details shown in FIGS. 2 through 42 and described above are for illustration and explanation only. Other embodiments of the graphical user interface 200 could also be used. For example, the content (such as the questions) and the arrangement of the content in FIGS. 2 through 42 are for illustration only. Other graphical user interfaces could use any other or additional content arranged in any suitable manner. As another example, a user's ability to access and modify various information shown in FIGS. 2 through 42 may be restricted based on the user's access privileges or other security requirements. Further, while the use of various input, output, and navigation mechanisms (such as drop-down menus, free-form text boxes, buttons, and links) have been described, any other or additional techniques could be used to obtain information from a user, provide information to a user, or navigate within the graphical user interface. Beyond that, any other or additional aspects of a transaction can be managed using the graphical user interface. In addition, while described as being used to facilitate transactions involving aviation assets, the graphical user interface could be used to facilitate transactions involving any suitable assets or types of assets.

Not only that, the use of the graphical user interface 200 (and the associated data collected and stored in the database 108) may facilitate various activities in addition to the actual performance of a transaction. For example, before an aviation asset can be sold, there often must be an inquiry into the history of the asset. This inquiry is often referred to as “due diligence” and can often require a comprehensive investigation of an asset. By facilitating one or multiple transactions associated with an aviation asset and collecting various information associated with that asset, the transaction support server 106 may facilitate easy access to a large quantity of information about the asset. This information could, for example, be easily extracted from the database 108 and used during a due diligence investigation. Again, this functionality could be used for a wide variety of assets or other property and need not be limited to use with aviation assets. As another example, the transaction support server 106 could collect information about multiple potential transactions and allow a user to compare different aspects of the transactions.

Moreover, as noted above, aircraft engines can be exchanged between aircraft. It is also possible that aircraft engines or other “sub-assets” associated with a main “asset” (such as an aircraft) can be involved in separate transactions apart from a transaction involving the aircraft. In addition, because aviation assets are often involved in multiple transactions, a user could review the information associated with a prior transaction and use/modify that information in the current transaction.

FIGS. 43 through 51 illustrate example methods for managing transactions involving aviation assets in accordance with this disclosure. The embodiments of the methods shown in FIGS. 43 through 51 are for illustration only. Other embodiments of the methods may be used without departing from the scope of this disclosure.

FIG. 43 illustrates an example method for displaying information in the summary section 202 of the graphical user interface 200. As shown in FIG. 43, a user selects a transaction at step 4302. This may include, for example, a user selecting a particular transaction using the transaction selection window 500. A transaction summary is presented to the user at step 4304. This may include, for example, the transaction support server 106 populating part of the summary section 202 with information about the selected transaction. The user selects an aircraft at step 4306. This may include, for example, the user selecting a particular aircraft using the aviation asset selection window 300 or the aircraft identifiers 212 associated with the selected transaction. An aircraft summary is presented to the user at step 4308. This may include, for example, the transaction support server 106 populating another part of the summary section 202 with information about the selected aircraft. The transaction support server 106 determines if the selected aircraft is involved in the selected transaction at step 4310. If so, the transaction support server 106 displays additional information specifically tying the selected aircraft and the selected transaction at step 4312. This may include, for example, the transaction support server 106 populating the remaining portion of the summary section 202 with information about the selected aircraft and transaction. Otherwise, the transaction support server 106 informs the user that the selected aircraft is not involved with the selected transaction at step 4314. The user can select a new aircraft or transaction at step 4316, and the method returns to step 4310.

FIG. 44 illustrates an example method for locating appropriate dates in a calendar application (such as SHAREPOINT) for display in the summary section 202 of the graphical user interface 200. As shown in FIG. 44, the transaction support server 106 examines a current SHAREPOINT calendar item at step 4402. The transaction support server 106 determines if the current item includes an identifier, such as a serial number, associated with a particular aircraft at step 4404. If so, the transaction support server 106 uses one or more keywords to identify a particular type of date at step 4406. This may include, for example, the transaction support server 106 distinguishing rent payment dates from insurance payment dates. If a match is found, the transaction support server 106 displays the date of the current item and a link to the relevant SHAREPOINT calendar item at step 4408. This may include, for example, the transaction support server 106 displaying the date in the summary section 202. Otherwise, the transaction support server 106 may select another item.

FIG. 45 illustrates an example method for displaying a checklist in the transaction information section 206 of the graphical user interface 200. As shown in FIG. 45, the transaction support server 106 selects a current question set and their associated answers (if any) at step 4502. This information may be obtained using a transaction identifier and a particular selected category. Also, the questions in the current question set could be modified by a user with appropriate authorization or security access. The transaction support server 106 determines if a particular level has been selected at step 4504 and, if so, highlights the appropriate entries in the transaction information section 206 at step 4506. The transaction support server 106 also determines if the user has requested that unanswered questions be identified at step 4508 and, if so, highlights the unanswered questions in the transaction information section 206 at step 4510. The transaction support server 106 displays the appropriate questions to the user with the appropriate highlighting and allows the user to provide input (such as answers to the questions) at step 4512.

FIG. 46 illustrates an example method for handling documents listed under the “Spreadsheets and Documentation” or the “Fleet/Specs/Operative Documents” tab 204 of the graphical user interface 200. A user adds a file to a file folder at step 4602, and the file is stored in a file server at step 4604. This may include, for example, the user adding a document or spreadsheet containing information associated with a transaction into a MICROSOFT WINDOWS folder. The documents or spreadsheets could include ABODE PDF files and MICROSOFT WORD and EXCEL files. The transaction support server 106 scans the file folder and stores file paths and file names in a database at step 4606. In some embodiments, the file paths and/or file names may include indicators associated with a transaction, an asset, and a security level. A database script is executed at step 4608 to identify these indicators, which represent metadata stored in an SQL server at step 4610. The metadata can then be displayed in the document index 4200 of the “Fleet/Specs/Operative Documents” tab 204 at step 4612 or the related document index 4100 of the “Spreadsheets and Documentation” tab 204 at step 4614.

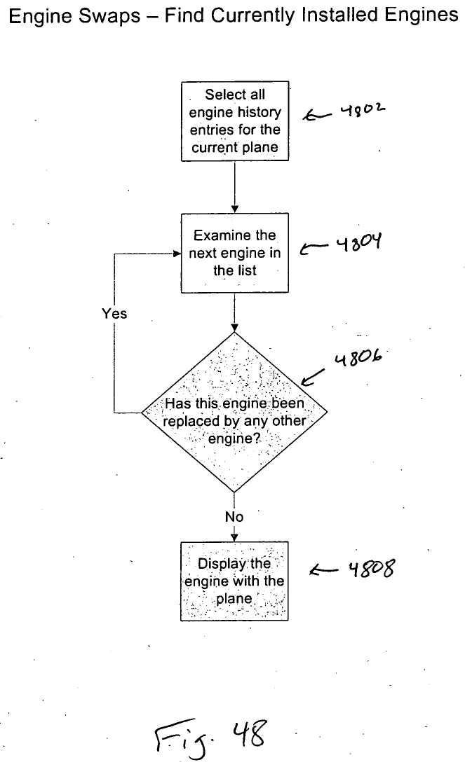

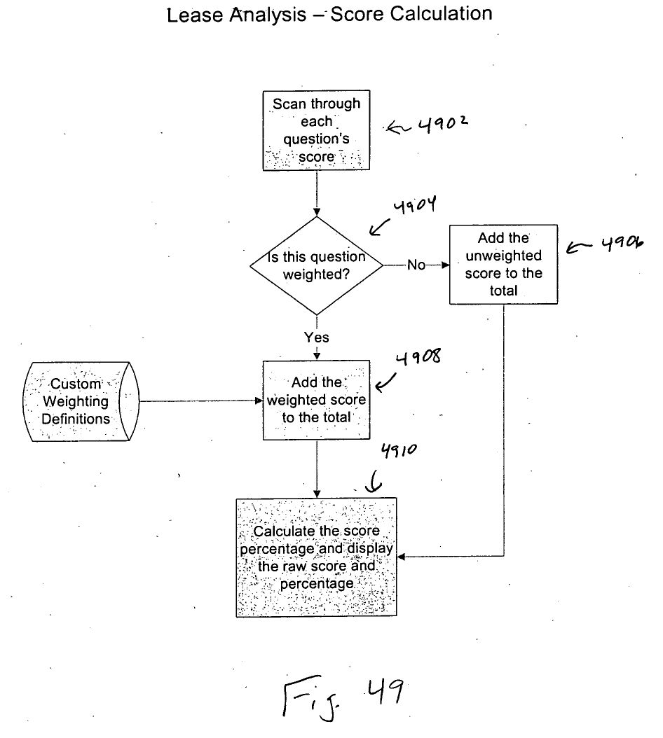

FIG. 47 illustrates an example method for processing email messages for display in the “Email” tab 204 of the graphical user interface 200. As shown in FIG. 47, a user sends an email message to a specified email account at step 4702. This may include, for example, the user sending an email message to an account accessible by the transaction support server 106. The email message is received and stored in a mail system mailbox at step 4704. The transaction support server 106 pulls email messages from the system mailbox at a specified interval at step 4706. The email messages may then be processed in any suitable manner. For example, metadata associated with the email messages may be identified and stored in an SQL server at step 4708. This metadata could be used to list the email messages in the email information 3900 of the “Email” tab 204 or to display the email in the email window 4000. The processed email messages could also be stored in a system mailbox at step 4710, which allows the email messages to be accessed via HTTP or other access technique.

FIG. 48 illustrates an example method for identifying the engines currently installed in a particular aircraft. As shown in FIG. 48, the transaction support server 106 selects all of the engine history entries for a particular aircraft at step 4802. This may include, for example, the transaction support server 106 searching the entries shown in the engine history edit window 800. The transaction support server 106 selects the next entry in the list at step 4804 and determines if that engine has been replaced or swapped at step 4806. If so, the transaction support server 106 returns to step 4804 to select the next engine in the list. Otherwise, the transaction support server 106 displays the engine as currently being associated with the aircraft at step 4808. At that point, the transaction support server 106 could return to step 4804 if any remaining engines need to be processed.

FIG. 49 illustrates an example method for generating a score, which appears at the top of the lease analysis checklist information 2500 under the “Lease Analysis” tab 204 of the graphical user interface 200. As shown in FIG. 49, the transaction support server 106 scans through each question's score as identified by the drop-down menu 2506 in each entry 2504 at step 4902. The transaction support server 106 determines if the question has a weighting at step 4904. If not, the unweighted score is added to a total score at step 4906. Otherwise, a weighted score determined using a custom weighting is added to a total score at step 4908. This process may be repeated for each question's score, and a total raw score and a percentage are generated and displayed at step 4910. The percentage may represent the total raw score divided by a maximum possible score. In some embodiments, weightings can be adjusted automatically, which could be done using any suitable criteria. For example, a weighting could be used to indicate that air carriers in third-world countries may be a more desirable leasing party for older aircraft or that the “lease term” is of more relative importance than the “governing law” of a lease.

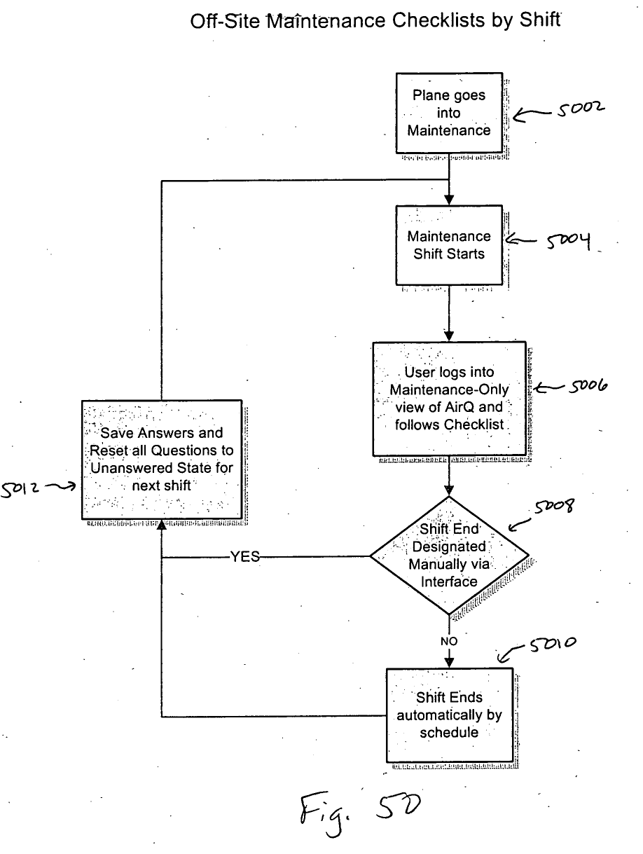

FIG. 50 illustrates an example method for updating the maintenance checklist information 3400 under the “Maintenance Checklists” tab 204 of the graphical user interface 200. An aircraft goes into a maintenance facility at step 5002. A maintenance shift begins at step 5004, and a user logs into the transaction support server 106 at step 5006 to follow the maintenance checklist. The user may be able to view only limited information stored in the database 108, such as the maintenance checklist only. The user may manually indicate that the user's shift has ended at step 5008 (such as by using the “End Shift” button in the controls 3406), or the user's shift may end automatically according to a schedule at step 5010. When either event occurs, the transaction support server 106 saves the user's answers and resets the maintenance questions to the unanswered state for the next maintenance shift.

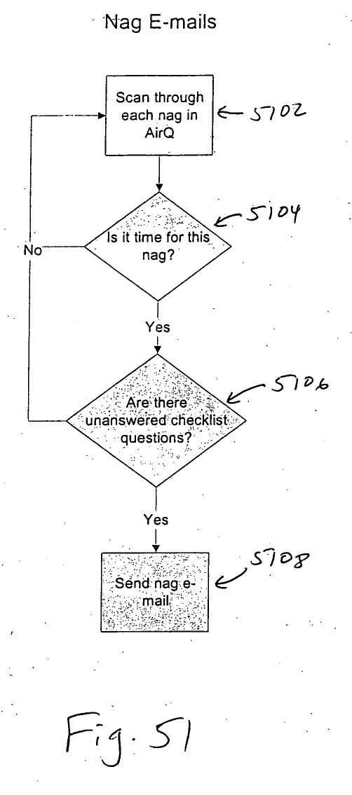

FIG. 51 illustrates an example method for generating reminders for particular questions in the graphical user interface 200. As shown in FIG. 51, the transaction support server 106 scans through each active reminder at step 5102. The transaction support server 106 determines if the time for a reminder to occur has been reached at step 5104. If so, the transaction support server 106 determines if one or more unanswered checklist questions are associated with the reminder at step 5106. If not, the transaction support server 106 returns to step 5102 to scan another reminder. Otherwise, a reminder is sent at step 5108, and the transaction support server 106 may return to step 5102 to scan another reminder.

The preceding description and related figures have described particular methods that could be used by the transaction support server 106 for managing transactions involving aviation assets. This represents particular embodiments of the various methods. Details shown in FIGS. 43 through 51 and described above are for illustration and explanation only. The transaction support server 106 could operate in any other or additional manner.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus, comprising:
at least one memory operable to store information associated with an aviation asset; and
at least one processor operable to:
generate a graphical display for presentation to one or more users, the graphical display containing at least a portion of the information associated with the aviation asset and a list of steps associated with a transaction involving the aviation asset; and
receive input from the one or more users indicating completion of each step associated with the transaction, the steps to be completed varying based on a transaction type associated with the transaction.

2. The apparatus of claim 1, wherein the graphical display includes:
a summary section containing the at least a portion of the information associated with the aviation asset; and
a transaction information section identifying the list of steps associated with the transaction.

3. The apparatus of claim 2, wherein the summary section includes a registration number, a registration country, a manufacture date, one or more engine serial numbers, and an identifier associated with an aircraft.

4. The apparatus of claim 3, wherein the summary section further includes at least one of:
multiple identifiers associated with multiple aircraft involved in the transaction; and
multiple identifiers associated with multiple transactions involving the aircraft.

5. The apparatus of claim 2, wherein each step in the transaction information section is associated with one or more input mechanisms for receiving the input from the one or more users.

6. The apparatus of claim 2, wherein:
the steps are divided into multiple groups in the transaction information section; and
the steps in each group are divided into different categories, the categories associated with different overall tasks or functions associated with the transaction.

7. The apparatus of claim 6, wherein:
the groups are associated with different tabs operable to be selected for viewing by the one or more users; and
the groups include groups associated with closing document preparation, transaction analysis, credit analysis, risk analysis, and asset maintenance.

8. The apparatus of claim 7, wherein:
the group associated with asset maintenance includes steps to be performed during maintenance of the aviation asset; and
a completion status of each step to be performed during the maintenance is reset in response to a maintenance shift ending.

9. The apparatus of claim 1, wherein:
multiple users are required to indicate completion of at least one of the steps; and
the multiple users are associated with different roles in the transaction.

10. The apparatus of claim 9, wherein the different roles represent different responsibilities or areas of expertise.

11. The apparatus of claim 1, wherein:
the aviation asset includes a sub-asset; and
the transaction represents a transaction associated with only the sub-asset and not the entire aviation asset.

12. The apparatus of claim 11, wherein the transaction involves an exchange of an engine between two different aircraft.

13. The apparatus of claim 1, wherein:
the list of steps includes a list of analyses associated with the transaction and a score associated with each analysis; and
the at least one processor is further operable to determine an overall score associated with the transaction based on the scores associated with the analyses.

14. The apparatus of claim 13, wherein each score associated with the analyses is based on whether a term of the transaction falls into a preferred, less desirable, or least desirable category.

15. The apparatus of claim 1, wherein:
the transaction represents a current transaction;
the aviation asset is associated with a prior transaction; and
at least some of the steps associated with the current transaction are completed based on the prior transaction.

16. The apparatus of claim 1, wherein:
the aviation asset represents at least one of: an aircraft and an aircraft engine; and
the transaction represents one of: a sale, a lease, and a rental of the aviation asset.

17. A method, comprising:
receiving information associated with an aviation asset;
generating a graphical display for presentation to one or more users, the graphical display containing at least a portion of the information associated with the aviation asset and a list of steps associated with a transaction involving the aviation asset; and
receiving input from the one or more users indicating completion of each step associated with the transaction, the steps to be completed varying based on a transaction type associated with the transaction.

18. The method of claim 17, wherein the information associated with the aviation asset includes at least one of:
multiple identifiers associated with multiple aviation assets involved in the transaction; and
multiple identifiers associated with multiple transactions involving the aviation asset.

19. The method of claim 17, wherein the list of steps includes steps to be performed during maintenance of the aviation asset; and
further comprising resetting a completion status of each step to be performed during the maintenance in response to a maintenance shift ending.

20. The method of claim 17, wherein:
multiple users are required to indicate completion of at least one of the steps; and
the multiple users are associated with different roles in the transaction.

21. The method of claim 20, wherein the different roles represent different responsibilities or areas of expertise.

22. The method of claim 17, wherein:
the aviation asset includes a sub-asset; and
the transaction represents a transaction associated with only the sub-asset and not the entire aviation asset.

23. The method of claim 22, wherein the transaction involves an exchange of an engine between two different aircraft.

24. The method of claim 17, wherein the list of steps includes a list of analyses associated with the transaction and a score associated with each analysis; and
further comprising determining an overall score associated with the transaction based on the scores associated with the analyses.

25. The method of claim 17, wherein:
the transaction represents a current transaction;
the aviation asset is associated with a prior transaction; and
at least some of the steps associated with the current transaction are completed based on the prior transaction.

26. A computer program embodied on a computer readable medium and operable to be executed by a processor, the computer program comprising:
computer readable program code for receiving information associated with an aviation asset;
computer readable program code for generating a graphical display for presentation to one or more users, the graphical display containing at least a portion of the information associated with the aviation asset and a list of steps associated with a transaction involving the aviation asset; and
computer readable program code for receiving input from the one or more users indicating completion of each step associated with the transaction, the steps to be completed varying based on a transaction type associated with the transaction.

27. The computer program of claim 26, wherein:
multiple users are required to indicate completion of at least one of the steps; and
the multiple users are associated with different roles in the transaction.

28. The computer program of claim 26, wherein:
the aviation asset includes a sub-asset; and
the transaction represents a transaction associated with only the sub-asset and not the entire aviation asset.

29. The computer program of claim 26, wherein the list of steps includes a list of analyses associated with the transaction and a score associated with each analysis; and
further comprising computer readable program code for determining an overall score associated with the transaction based on the scores associated with the analyses.

30. The computer program of claim 26, wherein:
the transaction represents a current transaction;
the aviation asset is associated with a prior transaction; and
at least some of the steps associated with the current transaction are completed based on the prior transaction.

31. A system, comprising:
a database operable to store information associated with an aviation asset;
a server operable to:
generate a graphical display for presentation to one or more users, the graphical display containing at least a portion of the information associated with the aviation asset and a list of steps associated with a transaction involving the aviation asset; and
receive input from the one or more users indicating completion of each step associated with the transaction, the steps to be completed varying based on a transaction type associated with the transaction; and
at least one user device operable to display the graphical display and provide the input from the one or more users to the server.
